(19) United States
(12) Patent Application Publication
(10) Pub. No.: US 2026/0368745 A1
(43) Pub. Date: Nov. 19, 2026

(54) Systems and Methods for Enterprise Management Interface

(71) Applicant: Veeva Systems Inc., Pleasanton, CA (US)

(72) Inventors: Arno Sosna, Pleasanton, CA (US); Chatham Reed, New York, NY (US); Alan Shijun Wang, Dublin, CA (US)

(73) Assignee: Veeva Systems Inc., Pleasanton, CA (US)

(21) Appl. No.: 19/675,298

(22) Filed: May 12, 2026

Related U.S. Application Data
(60) Provisional application No. 63/804,484, filed on May 12, 2025.

(51) Int. Cl. G06Q 30/01; G06F 16/3329; G06F 16/334; G06F 21/62; G06Q 30/018

(52) U.S. Cl. CPC G06Q 30/01; G06F 16/33295; G06F 16/3347; G06F 21/6245; G06Q 30/018

(57) ABSTRACT

A system for an enterprise management interface includes a customer relationship management (CRM) server configured to provide access to a CRM subsystem storing customer information, a controlled content repository storing approved content, and a user computing device executing a CRM client application. The CRM client application includes a user interface element providing access to a chat dialogue, wherein the user interface element is configured to capture context data based on a current location of a user within the CRM client application. An orchestrator is configured to receive a prompt from the user interface element along with the context data, transmit the prompt and the context data to a large language model (LLM) endpoint, and process a response from the LLM endpoint and return a result to the user interface element.

### CROSS-REFERENCE TO RELATED APPLICATIONS

This application claims priority U.S. Provisional Patent Application No. 63/804,484, filed on May 12, 2025, entitled Systems and Methods for AI Assisted Workflow Management, which is hereby incorporated by reference herein for all purposes.

### TECHNICAL FIELD

The present disclosure relates to the field of distributed computing and improvements in computer architecture and resource management including dynamically selecting and executing artificial intelligence (AI) agents on distributed computing hardware for scalable compute complexity.

### BACKGROUND

Artificial intelligence (AI) agents are trained to perform specific siloed tasks. The disparate and independent execution of the AI agents restricts greater compute complexity in a distributed computing environment that runs the AI agents and restricts usage of the compute resources on which the AI agents execute.

### BRIEF DESCRIPTION OF THE DRAWINGS

FIG. 1 illustrates an example architecture for AI assisted workflow management.

FIG. 2 illustrates an example architecture for the content repository of FIG. 1 in which content is built and organized in a controlled manner that facilitates efficient content generation.

FIG. 3 illustrates an example block diagram of a computing device, according to aspects of the present disclosure.

FIG. 4 illustrates an example of scaling the compute complexity of a distributed computing in accordance with some example embodiments presented herein.

FIG. 5 illustrates an example architecture with scalable and adaptable compute complexity for implementing different objectives or workflows in accordance with some example embodiments presented herein.

FIG. 6 illustrates an example of the signal collection driving the selective and collaborative artificial intelligence (AI) agent orchestration in accordance with some embodiments presented herein.

FIG. 7 illustrates an example of orchestrating the dynamic activation of AI agents to complete custom actions for executing an objective or workflow instance in accordance with some example embodiments presented herein.

FIG. 8 presents a process for dynamically generating actions based on the signal evaluation in accordance with some example embodiments presented herein.

FIG. 9 illustrates an example process of a method for unstructured text alignment, according to aspects of the present disclosure.

FIG. 10 illustrates an example user interface depicting a call report with an alignment issue detected by the unstructured text alignment monitoring agent in accordance with some example embodiments.

FIG. 11 illustrates an example user interface depicting a call report with an alignment issue detected by the unstructured text alignment monitoring agent after a remedial action is selected in accordance with some example embodiments.

FIG. 12 illustrates an example user interface depicting a call report with alignment issues fixed accordance with some example embodiments.

FIG. 13 illustrates an example user interface depicting a call report populated from a voice agent in accordance with some example embodiments.

FIG. 14 illustrates an example user interface depicting a call report populated from a voice agent that has been analyzed by the unstructured text alignment monitoring agent in accordance with some example embodiments.

FIG. 15 illustrates an example process of a method for voice-based data capture and alignment, according to aspects of the present disclosure.

FIG. 16 illustrates a user interface of a CRM application displaying a scheduler view with an integrated AI assistant chat panel providing pre-call planning assistance.

FIG. 17 illustrates a CRM scheduler view with the AI assistant chat panel displaying a response to a next best actions query.

FIG. 18 illustrates a CRM scheduler view with the AI assistant chat panel displaying an interaction summary.

FIG. 19 illustrates a user interface of a CRM application displaying a Speaker Program event creation form with an error state and an integrated AI assistant chat panel providing contextual error assistance.

FIG. 20 illustrates events management Speaker Program event creation form with the AI assistant chat panel displaying an error explanation and actionable remedial options.

Although similar reference numbers may be used to refer to similar elements for convenience, it can be appreciated that each of the various example embodiments may be considered to be distinct variations.

The present embodiments will now be described hereinafter with reference to the accompanying drawings, which form a part hereof, and which illustrate example embodiments which may be practiced. As used in the disclosures and the appended claims, the terms “embodiment” and “example embodiment” do not necessarily refer to a single embodiment, although it may, and various example embodiments may be readily combined and interchanged, without departing from the scope or spirit of the present embodiments. Furthermore, the terminology as used herein is for the purpose of describing example embodiments only, and are not intended to be limitations. In this respect, as used herein, the term “in” may include “in” and “on,” and the terms “a”, “an”, and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated list items.

### DETAILED DESCRIPTION OF PREFERRED EMBODIMENTS

This disclosure arises from the realization that compute resources are not maximized when artificial intelligence (AI) agents are deployed to run siloed tasks independent of one another and without coordination. The compute capabilities and compute complexity of the AI agents and the compute resources are limited to the complexity associated with each individual task.

The current disclosure provides a technical solution for a technological problem in the field of distributed computing. The technical solution includes improving computer architecture and resource management by orchestrating and/or dynamically controlling the execution of different AI agents towards the execution of a collective objective or workflow rather than the siloed tasks executed by each AI agent. Running the AI agents with orchestration creates a distributed computing environment that scales or increases the compute capability and compute complexity of the AI agents without increasing the compute resources on which the AI agents execute and without extending the compute capability or compute complexity associated with each AI agent. In particular, the orchestration enables the execution of larger and/or more complex objectives or workflows using the same set of AI agents running on the same set of compute resources based on the dynamic and selective combined execution of different sets of AI agents without training a single AI agent to execute the myriad tasks associated with the larger objective or workflow and/or without training a different AI agent for each objective or workflow when different objectives or workflows involve shared or common tasks.

The technical solution includes defining an AI agent orchestrator that dynamically and selectively invokes different AI agents in order to scale the compute complexity associated with the siloed tasks performed by each AI agent for the greater compute complexity needed to implement objectives or workflows that include shared or common tasks performed by the different AI agents. The AI agent orchestrator receives signals that target different objectives or workflows effectuated by the AI agent orchestrator. In some example embodiments, the AI agent orchestrator uses one or more AI agents to interface with the different signal sources and extend the types of signals that the AI agent orchestrator receives. The AI agent orchestrator may evaluate and/or score the signals in order to measure the signal impact on a targeted objective or workflow. The AI agent orchestrator may selectively invoke different AI agents to perform different coordinated or chained actions that the AI agent orchestrator dynamically defines for completing a targeted objective or workflow based on the signal evaluation and/or scoring. For example, the targeted objective may include boosting sales of a particular product. In this example, the AI agent orchestrator may invoke a first set of AI agents to perform a first set of actions for a first customer based on signals that modify the objective relative to the first customer, and may invoke a second set of AI to perform a second set of actions for a second customer based on different signals that modify the objective relative to the second customer. Invoking the first set of AI agents may include coordinating or controlling the execution of the first set of AI agents by determining, providing, and/or formatting the output of one or more of the first set of AI agents as input to another AI agent of the first set of AI agents. In this manner, the AI agent orchestrator generates a distributed computing environment for objectives and workflows of different compute complexity based on the selective execution of independent AI agents in a cloud computing environment.

In some example embodiments, the AI agent orchestrator is implemented within a customer relationship management (CRM) platform to enable dynamic, data-driven coordination of AI agents that manage and automate CRM workflows. In some such example embodiments, the AI agent orchestrator may evaluate a set of received signals relative to one or more active business objectives (e.g., increasing conversion probability, customer retention, or campaign responsiveness). Based on the evaluation, the AI agent orchestrator may dynamically select and invoke a subset of already deployed AI agents that are configured to execute and/or automate actions for advancing the business objectives. By orchestrating the execution of the AI agents within the CRM platform, the AI agent orchestrator enables distributed execution of multi-stage CRM operations that exhibit greater compute complexity and adaptability than any single AI agent executing in isolation, without requiring expansion of compute resources or retraining of monolithic models.

The present disclosure relates to systems and methods for artificial intelligence (AI) assisted workflow management, and more specifically to systems and methods for AI agent orchestration and unstructured text alignment monitoring in regulated industries such as life sciences. The disclosed systems and methods leverage AI models, controlled content repositories, and customer relationship management (CRM) subsystems to coordinate distributed AI agents and monitor unstructured text inputs for compliance with regulatory requirements.

In regulated industries, the communication of information to healthcare professionals (HCPs) may be subject to stringent compliance requirements. Free-text inputs in call reports and other communications have historically been avoided due to the risks associated with non-compliance, including the dissemination of off-label messaging, the inclusion of personal health information (PHI) or personally identifiable information (PII), and other regulatory violations. Conventional systems have relied on structured inputs such as picklists and standardized templates to reduce compliance risks. However, these approaches may fail to capture the full context and nuances of HCP interactions, leading to incomplete or overly rigid documentation that may hamper operational efficiency and the ability to derive actionable insights.

AI agents may be trained to perform specific siloed tasks. The disparate and independent execution of AI agents may restrict greater compute complexity in a distributed computing environment that runs the AI agents and may restrict usage of the compute resources on which the AI agents execute. Managing distributed AI agents presents challenges in coordinating the execution of different agents towards collective objectives or workflows rather than the siloed tasks executed by each individual agent.

The disclosed systems and methods address these challenges by providing AI agent orchestration that coordinates and controls the execution of different AI agents towards the execution of collective objectives or workflows. The orchestration may create a distributed computing environment that scales or increases the compute capability and compute complexity of the AI agents without increasing the compute resources on which the AI agents execute and without extending the compute capability or compute complexity associated with each AI agent. The orchestration may enable the execution of larger or more complex objectives or workflows using the same set of AI agents running on the same set of compute resources based on the dynamic and selective combined execution of different sets of AI agents.

The disclosed systems and methods further provide free text compliance monitoring that utilizes AI models, including large language models (LLMs), to analyze user-authored free-text entries, detect non-compliant content, and suggest remedial actions. By conditioning a compliance model with standard operating documents and regulatory rules, the systems and methods may promote adherence of free-text inputs to industry-specific requirements while preserving the richness of the information captured. The systems and methods may perform semantic searches through an approved content repository to verify the accuracy of product facts and identify supporting documentation, thereby enhancing compliance and trustworthiness. The disclosed architecture may integrate a controlled content repository, a CRM subsystem, and a multichannel processing engine to generate tailored communications that comply with regulatory standards while creating immutable audit records linking communication content, delivery channels, and recipient profiles.

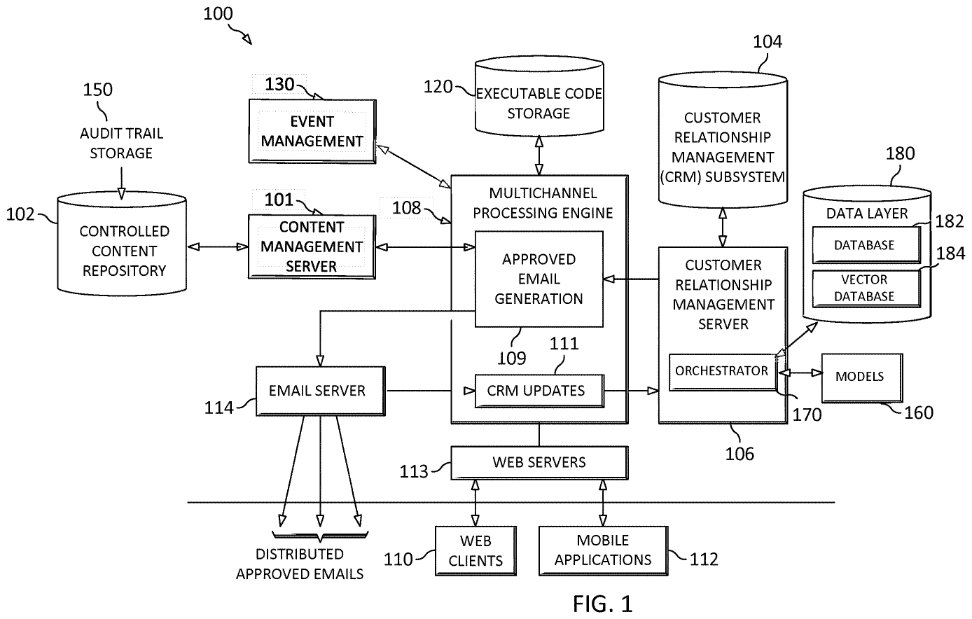

FIG. 1 is a system overview illustrating an embodiment of an AI assisted workflow management system 100. The presently disclosed embodiment comprises a controlled content repository 102, a Customer Relationship Management (CRM) server 106, a multichannel processing engine 108, an event management controller 130, a data layer 180 and models 160. The customer relationship management server 106 includes an orchestrator 170 and may provide access to a customer relationship management subsystem 104. The multichannel processing engine 108 may be coupled to an email server 114, the content management server 101, the CRM server 106 and the event management controller 130. In one embodiment, the customer relationship management subsystem 104 and/or the email server 114 may be operated by a third party. The multichannel processing engine 108 may be accessed by users such as company sales representatives through web clients 110 or through mobile apps 112 (such as iOS, Android, Blackberry, or Windows Mobile systems), communicating with the multichannel processing engine 108 through web servers 113. Although the users may be described in the present application as being company sales representatives, this particular described embodiment is not intended to limit the generality of the claims that may eventually issue in patents stemming from the present disclosure.

The controlled content repository 102 is designed to have a process for developing approved content that is sharable across multiple users, such as shareholders, reviewers, managers, marketing personnel, sales representatives, etc. The content generated in the controlled content repository 102 may be accessed on a regulated basis and used to generate approved electronic communications. This regulated basis may be determined, in part, by the company as a whole and additionally by interaction with data from the customer relationship management subsystem 104, described in further detail below. In one embodiment, approved content, customer profile information, customer preferences, and regulatory limitations and requirements may be stored in a table in the controlled content repository 102. In addition to storage and development of content, the controlled content repository 102 may also store an audit trail, tracking exact content of communications as they were sent by the user (e.g. pharmaceutical rep), as well as metadata about the communications and information regarding the content accessed by recipients (e.g. HCP).

The customer relationship management subsystem 104 contains all professional information of HCPs that may be available to users, including contact information, licensing information, areas of practice, and specialties. In addition, the customer relationship management subsystem 104 may also be capable of storing configurations regarding specific preferences, regulatory limitations and requirements, and other fields that will facilitate the generation of appropriate approved electronic communications, in general or on a by recipient basis. These preferences and/or requirements include both the preferences of the user (e.g., maintaining account lists) as well as the preferences of the enterprise (e.g., employers of the users), discussed in further detail below. In some examples, the approved content and email templates may be pre-processed and stored in the controlled content repository 102 and provided to the multichannel processing engine 108 during the process for generating a tailored approved email. In other examples, the customer relationship management subsystem 104 may have a content management subsystem and may provide the approved content and the templates.

Models 160 may comprise one or more artificial intelligence models configured to support compliance monitoring, content analysis, and natural language processing functions within the system.

Models 160 may include a compliance model configured to analyze user-authored free-text entries in call reports or workflow management applications. The compliance model may be implemented as a large language model (LLM) or similar AI model. The compliance model may be conditioned with prompt context comprising regulatory rules, approved reference language, and product-specific standard operating documents retrieved from controlled content repository 102. The compliance model may analyze free-text entries to identify non-compliant content, such as off-label messaging, protected health information (PHI), or personally identifiable information (PII). Upon detecting non-compliant content, the compliance model may detect divergences between the non-compliant content and retrieved reference passages and may automatically generate remedial actions, including visually highlighted divergent segments and proposed compliant replacement text.

Models 160 may further include one or more embedding models configured to generate vector embeddings from textual content. An embedding model may be selected based on a number of factors including performance relating to model-specific embedding quality, dimensionality wherein higher dimension vectors capture more nuance but increase storage and compute cost, context window representing the maximum input size the model can process for a single chunk, and domain specificity wherein a model fine-tuned for a particular industry such as the life sciences industry may improve semantic accuracy. Each cleaned and chunked text segment from controlled content repository 102 may be passed through the chosen embedding model to generate a corresponding D-dimensional vector embedding, which represents the semantic meaning of the chunk in a high-dimensional space. The generated vector embeddings may be stored in vector database 184 within data layer 180.

Models 160 may be accessed via an LLM endpoint, which may be an API-accessible LLM service. The LLM endpoint may support function calls that enable orchestrator 170 to invoke specific operations during compliance checking and content analysis workflows. In some implementations, models 160 may include content filters and guardrails wherein certain questions may be off-limit and the LLM may be allowed to answer some questions but not others. The content filters may be based on customer rules or standard settings configured directly in the LLM.

Models 160 may operate in conjunction with data layer 180 to support retrieval-augmented-generation (RAG) flows. In a RAG flow, vector database 184 may be queried to retrieve passages related to a user query or compliance concern, and the retrieved passages may be supplied to models 160 for inclusion in a synthesized answer. The RAG flow may perform semantic search through controlled content repository 102 to identify supporting documentation related to text entries, enabling the compliance model within models 160 to compare user text against approved reference language and identify divergences.

In some implementations, models 160 may leverage a shared LLM service, text embedding service, and content vector store implemented to support multiple CRM agents. Models 160 may process user inputs in any language supported by the LLM, while LLM reasoning and other portions of the response used in logging may be generated in a default language such as English. Models 160 may be configured to explain assessment rationale and provide a confidence interval with a score indicating the certainty of findings when performing compliance analysis.

Models 160 may be invoked by orchestrator 170 to perform compliance checking across multiple compliance issue categories. The compliance issue categories may include inappropriate content screening to identify restricted words, profanity, and inappropriate content using the LLM's background training and understanding of professional language in the life sciences industry. The compliance issue categories may further include data protection screening to identify entry of PHI or PII in unencrypted fields, promotional compliance screening to identify off-label product promotion, product restriction screening to identify mentions of restricted products, and safety vigilance screening to detect adverse events, serious adverse events, or product quality complaints.

In some implementations, models 160 may be configured to cite the source slide or document for any information provided as an extra layer of assurance and quality protection that the model response is factual and correct. Models 160 may include knowledge boundary enforcement instructions wherein the LLM should not make assumptions if context is unavailable through provided tools and should state that context is not available rather than generating potentially inaccurate information.

The data layer 180 includes a database 182 storing structured and unstructured data, as well as a vector database 184 for optimal use with models 160, which stores high-dimensional numerical vectors capturing semantic meaning. The data layer 180 transforms conventional data in the database 182 into the vector form that enables models 160 to access and utilize domain-specific context in a fast and efficient manner. In one example embodiment, the data layer 180 may initially retrieve approved content from the controlled content repository 102 through an Applications Programming Interface or API. The approved content may be converted and vectorized using a multi-phase process. The initial phase may involve extracting relevant data and preparing the approved content for vectorization. Textual content from database 182 may be extracted by querying fields that contain natural language data, such as descriptions, document bodies, etc. Data cleaning techniques may be applied to normalize the approved content. Non-informative words are removed and text cases are standardized to remove lowercasing. Metadata may be integrated to identify and extract key attributes from database 182.

Due to the limited context window size of embedding and large language models (LLMs), large documents must be split into smaller, semantically coherent units. A number of chunking strategies may be utilized including, but not limited to, fixed-size chunking with overlap (e.g., splitting text into chunks of a set token/character size with a small, strategic overlap (e.g., 10-20%) between adjacent chunks to maintain semantic continuity across boundaries), or sentence/paragraph-based chunking (e.g., splitting based on natural document structure (sentences, paragraphs, or section headers) to ensure each chunk represents a complete thought or concept. For each resulting chunk, the associated metadata (e.g., the original document's unique ID, title, and other structured attributes) may be attached to allow models 160 to provide source attribution and enables filtered vector search.

An appropriate embedding model in models 160 may be utilized. Selection may be based on a number of factors including: performance (model specific embedding quality), dimensionality (higher dimension vectors capture more nuance but increases storage/compute cost), context window (maximum input size the model can process for a single chunk), and domain specificity (fine-tuned model in the life sciences industry improves semantic accuracy). Each cleaned and chunked text segment is passed through the chosen embedding model to generate a corresponding D-dimensional vector embedding, which represents the semantic meaning of the chunk in a high-dimensional space.

Each D-dimensional vector embedding is stored in the vector database 184 and indexed. An indexing strategy may be utilized to accelerate similarity search. Vector database 184 may allow for semantic searching by models 160 (e.g. an LLM). In some implementations, content may be uploaded to a promotional materials system and may undergo medical and legal review. After the content is approved, the content may be stored in the controlled content repository to be accessed by user devices. In parallel, the approved content may be chunked and transformed into the vector database.

In some implementations, prescribing information (PI) reference documents and compliance documents may be vectorized and stored in vector database 184. Vector database 184 may be automatically updated whenever reference documents are incrementally created, updated, or deleted. The automatic updates may ensure that compliance analysis is performed against current approved content. An administrator may initiate a vector database synchronization process through a configuration interface, wherein the synchronization process vectorizes approved reference documents and compliance documents for storage in the vector database.

In other examples, the customer relationship management subsystem 104 may have a content management subsystem and may provide the approved content. The customer relationship management subsystem 104 may store event related data, e.g., a link to approved content in the controlled content repository 102, a speaker list, upcoming and past event date/time/locations/topics, content associated with each event, content sharing rules allowing access to content based on speaker qualifications, contracts associated with an associated speaker, and webinar tracking information as will be described in detail below.

In one embodiment, the event related data, e.g., a link to approved content in the controlled content repository 102, a speaker list, upcoming and past event date/time/locations/topics, content associated with each event, content sharing rules allowing access to content based on speaker qualifications, contracts associated with an associated speaker, and webinar tracking information may be stored in the controlled content repository 102.

In this embodiment, the customer relationship management subsystem 104 is capable of communication with multiple sources through the customer relationship management server 106 or through other channels to maintain a current and accurate collection of information regarding customer accounts. The interface with the multiple sources can be, for example, through an Applications Programming Interface or API, as the API interface will allow compatibility with a flexible array of third-party provider servers. The information being updated may include, but is not limited to, licensing information, area of practice, and location of the various customer contacts. In this manner, the customer relationship management subsystem 104 pulls the approved version of what represents an account or physician, which then pulls from multiple networks to ensure that the information regarding an account is up-to-date. The customer relationship management subsystem 104 may also be used to determine the type of domain an email communication is delivered through. A recipient in Spain may receive an email from “Companyx.es, whereas a recipient in Germany would receive the same email from “Companyx.ge.” This may allow for additional branding options for the company controlling and sending the electronic communications.

With further reference to the customer relationship management subsystem 104, this system may be a cloud-based customer database that provides a central access to store and distribute consistent data across customer companies as well as their possible third-party partners and agencies that are used to keep this data updated. This system can provide standard data formats and provide an easy and automated way for customers (e.g. pharmaceutical companies campaign manager) and/or users (e.g. pharmaceutical reps) to have access to coordinated and frequently updated CRM data and to use that coordinated data for sending approved electronic communications in accordance with the system described herein. In an embodiment, the multichannel processing engine 108 is responsible for combining the customer account information from the customer relationship management subsystem 104 with content available from the controlled content repository 102. Within the customer relationship management subsystem 104, customer accounts may be assigned a set of alignment rules which determine specific pieces of content that are available for use from the controlled content repository 102. The multichannel processing engine 108 may apply these rules and supply the user with a list of approved tailored email templates and pieces of content that may then be used to construct a tailored approved email communication. Tailored approved email generation occurs within the multichannel processing engine 108 according to executable code computer instructions stored in executable code storage 120. The executable code comprises computer readable instructions stored on the computer readable medium (the code storage medium 120). The executable code storage 120 is in communication with the various computing machines in the system 100 such as the customer relationship management server 106 and the multichannel processing engine 108. The same or another executable code storage 120 may be accessed by the previously described components of the controlled content repository 102 for providing separate computer readable code for operating upon by processing machines in that system. In all cases, the code is programmed to perform the functions that are described in the present embodiments and/or additional functions according to system design needs.

Communication between the multichannel processing engine 108 and the customer relationship management subsystem 104 may occur via the customer relationship management server 106, which acts as an interface between the two. The customer relationship management server 106 may act solely as an entry and exit point for the customer relationship management subsystem 104. The user may access the multi-channel processing engine 108 through either a Web Client 110 or through the mobile apps 112 (such as iOS, Android, Blackberry, or Windows Mobile systems).

The event management controller 130 may store event related information, such as information about attendees and speakers, event content, and event details.

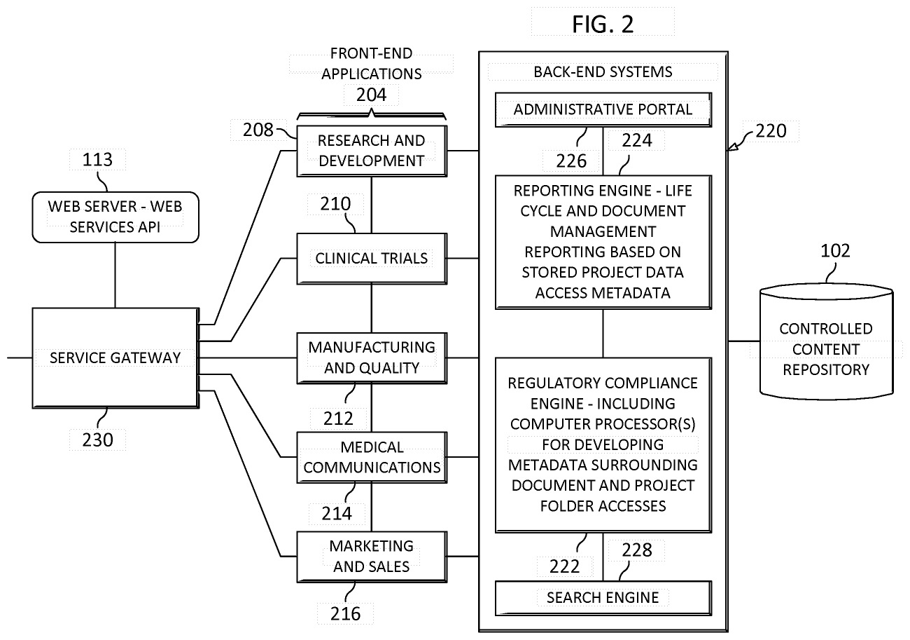

FIG. 2 provides a description of the controlled content repository 102 with additional specific applications and interfaces connected thereto. In an embodiment, this controlled content repository 102 is a cloud-based or distributed network-based system for consolidating an enterprise's data, often times integrating multiple content repositories in an enterprise into a single system having coordinated control, measuring, and auditing of data creation, access and distribution.

In an embodiment of the controlled content repository 102 for the life sciences industry, as illustrated in the figure, this repository 102 can include specific data collections for the following areas and/or business process-specific front-end applications 204: The Research & Development (R&D) front end application 208 provides for an aggregation of materials in support of research and initial clinical trial submissions through building organized and controlled content repositories within the controlled content repository 102. Elements that can be stored, organized, and managed through this frontend include submission bills of materials, Drug Information Association (DIA) reference models support, and submission-ready renderings. This front end 208 is designed to provide an interface to the controlled content repository 102 whereby researchers, contract research organizations (CROs), and other collaboration partners can access and/or distribute content through a single controlled document system.

The clinical trials front-end application 210 provides for faster and more organized access to trial documents and reports, while supporting seamless collaboration between sponsors, CROS, sites, investigators and other trial participants. Specific features both ease study and site administration as well as support the DIA trial master file (TMF) reference model. Having this front-end application providing access to the controlled content repository 102 further provides for efficient passing off of controlled content repository content between this phase and other phases of the life sciences development process. The manufacturing and quality application 212 enables the creation, review, approval and distribution of controlled documents across the organization and with external partners in the context of materials control and other manufacturing elements. The application 212 provides functionality in support of the manufacturing process including watermarking, controlled print, signature manifestation and “Read and Understood” signature capabilities. The documents and metadata associated with this process is managed and stored in the controlled content repository 102 whereby it can be assured that the related documents are not distributed in contravention of law and company policy.

The medical communications application 214 provides for communications with medical facilities, including call center access, integration, and interface functionality. Particular access control features and metadata associated with this application 214 include expiration and periodic review elements, multi-channel support, global documents and automatic response package generation through the controlled content repository 102.

The marketing and sales application 216 application provides an end-to-end solution for the development, approval, distribution, expiration and withdrawal of promotional materials. Specific features include Support for global pieces, approved Form FDA 2253 (or similar international forms) form generation, online document, and video annotation, and a built-in digital asset library (DAL). Again, the communications may be through the controlled content repository 102. In disclosed embodiments, there are provided a number of back-end system applications 220 that provide for the management of the data, forms, and other communications in the controlled content repository. For example, the back-end systems applications 220 may include a regulatory compliance engine 222 to facilitate regulatory compliance, including audit trail systems, electronic signatures systems, and system traceability to comply with government regulations, such as 21 CFR Part 11, Annex 11 and GXP-related requirements. The regulatory compliance engine 222 may include processors for developing metadata surrounding document and project folder accesses so from a regulatory compliance standpoint it can be assured that only allowed accesses have been permitted. The regulatory compliance engine 122 may further includes prevalidation functionality to build controlled content in support of installation qualification (IQ) and/or operational qualification (OQ), resulting in significant savings to customers for their system validation costs.

In further disclosed embodiments, the back-end systems 220 may contain a reporting engine 224 that reports on documents, their properties and the complete audit trail of changes. These simple-to-navigate reports show end users and management how content moves through its life cycle overtime, enabling the ability to track plan versus actual and identify process bottlenecks. The reporting engine may include processors for developing and reporting life cycle and document management reporting based on Stored project data and access metadata relative to documents, forms and other communications stored in the controlled content repository 102.

In further disclosed embodiments, the back-end systems 220 can include an administrative portal 226 whereby administrators can control documents, properties, users, security, workflow and reporting with a simple, point-and-click web interface. Customers also have the ability to quickly change and extend the applications or create brand new applications, including without writing additional software code.

In further disclosed embodiments, the back-end systems 220 may include a search engine 228 whereby the controlled content repository 102 can deliver simple, relevant and secure searching. In providing this holistic combination of front-end applications 204 and back-end system applications 220, the various applications can further be coordinated and communicated with by the service gateway 230, which in turn can provide for communications with various web servers and/or web services APIs 113. Such web servers and/or web services APIs 113 can include access to the content and metadata layers of some or all of the various applications 204 and systems 220, enabling seamless integration among complementary systems.

In the context of the described embodiments, the particular features and capabilities integrate with the other elements of the controlled email communication system 100 such that particular features are usable within the various user screens. For example, and without limitation to any other possible combination of features, in the below-described description of generating a tailored approved electronic communication, the above-described search portal can be used to search for approved attachments (i.e. content) within the controlled content repository 102 which may be then attached to one of the tailored template emails being prepared for sending to a recipient. And the synergy of combining these particular systems is that the generation of the controlled content can be done in a controlled fashion such that the approved content can be sent to recipients with greater confidence in the integrity of the data being sent.

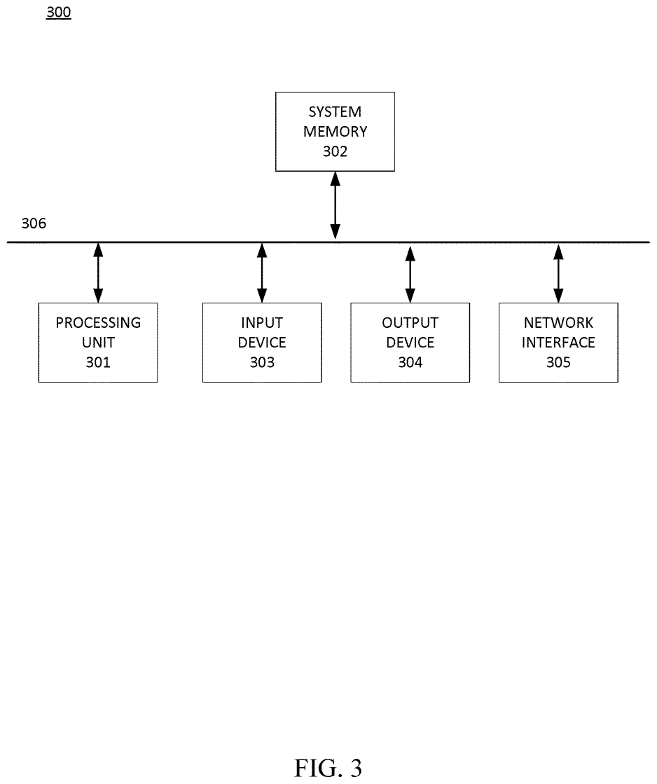

FIG. 3 illustrates an example block diagram of a computing device 300 which can be used as customer relationship management server 106, and user computing devices accessing web clients 110 and mobile applications 112 in FIG. 1. The computing device 300 is only one example of a suitable computing environment and is not intended to suggest any limitation as to scope of use or functionality. The computing device 300 may include a processing unit 301, a system memory 302, an input device 303, an output device 304, a network interface 305 and a system bus 306 that couples these components to each other.

The processing unit 301 may be configured to execute computer instructions that are stored in a computer-readable medium, for example, the system memory 302. The processing unit 301 may be a central processing unit (CPU). In an alternate embodiment, the processing unit 301 may be implemented through parallel processing architectures designed to optimize high-volume data transformations and multi-market synchronization. Such architectures may include multi-core processors, symmetric multi-processing (SMP) systems, or a plurality of discrete processors operating in a multi-processing arrangement. In some example implementations, the processing unit 201 may incorporate a Graphics Processing Unit (GPU) or a hardware accelerator (e.g., an Application-Specific Integrated Circuit (ASIC) or Field-Programmable Gate Array (FPGA) configured to accelerate AI-based operations, checks or to facilitate the simultaneous AI-implemented workflows in a single operation. Furthermore, parallel processing may involve distributing computational tasks across a networked computing environment, such as a computing grid or cloud environment, where separate virtual machine instances or containers process disparate workflows in parallel. This parallelized execution significantly reduces the computational latency and processor overhead required.

The system memory 302 typically includes a variety of computer readable media which may be any available media accessible by the processing unit 301. For instance, the system memory 302 may include computer storage media in the form of volatile and/or nonvolatile memory such as read only memory (ROM) and/or random access memory (RAM). By way of example, but not limitation, the system memory 302 may store instructions and data, e.g., an operating system, program modules, various application programs, and program data.

A user can enter commands and information to the computing device 300 through the input device 303. The input device 303 may be, e.g., a keyboard, a touchscreen input device, a touch pad, a mouse, a microphone, and/or a pen.

The computing device 300 may provide its output via the output device 304 which may be, e.g., a monitor or other type of display device, a speaker, or a printer.

The computing device 300, through the network interface 305, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network and/or buses. The network interface 305 may be configured to allow the computing device 300 to transmit and receive data in a network. The network interface 305 may include one or more network interface cards (NICs).

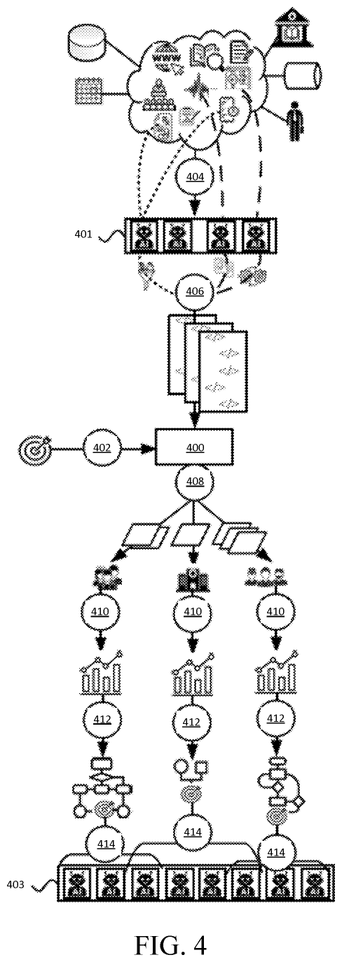

FIG. 4 illustrates an example of scaling the compute complexity of a distributed computing environment executing different AI agents by orchestrating the selective execution of the AI agents in accordance with some example embodiments presented herein. AI agent orchestrator 400 (e.g., orchestrator 170) is configured (at step 402) with automating one or more high-level objectives or workflows. The high-level objectives or workflows may be defined textually or may be modeled based on existing objectives or workflows performed by an organization. In some example embodiments, an objective or workflow may be specified as a desired outcome or end result without enumerating the tasks associated with reaching that desired outcome or end result. For instance, the high-level objective for a particular entity may include boosting sales for different products or services of the organization.

AI agent orchestrator 400 receives (at step 404) signals that originate from different data sources and that have contextual and/or temporal relevance to the configured (at step 402) objectives or workflows. The signals may include quantitative data, qualitative data, and/or data in a variety of formats with a variety of attributes.

First set of AI agents 401 may interface with the different data sources in order to provide (at step 406) the signals in a common or accepted format to AI agent orchestrator 400. For instance, a first AI agent from first set of AI agents 401 may perform sentiment analysis over qualitative data and provide the sentiment analysis as a signal to AI agent orchestrator 400, a second AI agent from first set of AI agents 401 may generate a summary of recorded audio and provide the textual summary as a signal to AI agent orchestrator 400, and a third AI agent from first set of AI agents 401 may remove personally identifiable information (PII) or other private or confidential data from the received (at step 404) signal for compliance purposes. In any case, first set of AI agents 401 may enforce a data package protocol that converts the signals received (at step 404) in various first formats to a common second format for signals that are processed by AI agent orchestrator 400.

AI agent orchestrator 400 sorts (at step 408) the signals based on relevance to different objectives or workflows. In some example embodiments, the different objectives or workflows may correspond to different instances of the same objective or workflow being performed for different targets (e.g., different customers, potential customers, employees, products, services, etc.). For instance, the signals may identify conferences attended by healthcare professionals or other users associated with a given entity, medications prescribed by the healthcare professionals of the given entity, tracked online activity of healthcare professionals, publications relevant to fields of medicine or healthcare provided by the healthcare professionals and/or at the given entity, and/or other data that is directly or indirectly attributable to the healthcare professionals or the given entity. AI agent orchestrator 400 may sort (at step 406) the signals to attribute the data collected on healthcare professionals of the given entity to that entity.

In some embodiments, the signals further encompass data associated with non-personal promotion or non-personal promotional actions, including campaign-level performance data, channel engagement metrics, or aggregated market analytics that are not attributable to a specific person or entity. AI agent orchestrator 400 may sort (at step 406) the non-personal signals to the different objectives or workflows. For instance, a particular objective for increasing sales may be affected by non-personal signals that indicate the effectiveness of different promotional actions across different products or customers. Accordingly, the inclusion of non-personal signals allows AI agent orchestrator 400 to optimize both individualized and broad-scale objectives within a unified orchestration framework, thereby extending orchestration control beyond customer-specific workflows to include generalized campaign-level workflows.

AI agent orchestrator 400 evaluates (at step 410) the sorted (at step 408) signals. The evaluation (at step 408) may include determining the importance or impact that each signal has on the objective or workflow. For instance, if the objective or workflow is to increase sales of pharmaceuticals, then the evaluation (at step 410) may include prioritizing or attributing greater significance to signals that indicate a customer or potential customer's interest in the pharmaceuticals and deprioritizing or attributing lesser significance to signals that do not impact sales of the pharmaceuticals. Signals that indicate an interest in a particular pharmaceutical may include data that tracks a healthcare professional researching treatments for an indication treated by the particular pharmaceutical, detecting searches related to publications about the indication or the particular pharmaceutical, and/or determining a number of patients being treated for the indication. The evaluation (at step 410) may include scoring each signal based on its derived importance to the objective or workflow.

AI agent orchestrator 400 defines (at step 412) a different set of actions for effectuating each instance of the objective or workflow based on the signal evaluation (at step 410). The signal evaluation (at step 410) may be used to determine the preferences of an entity that is targeted in a particular instance of the objective or workflow and for customizing the set of actions to cater to, satisfy, or address those preferences. For instance, the preferences may indicate that the targeted entity has numerous patients with a particular ailment that is treatable with specific medicine offered by the manufacturer, may indicate that healthcare professionals associated with the targeted entity have attended conferences or reviewed studies about the specific medicine, and may indicate that the healthcare professionals do not read or view emails from the manufacturer. Accordingly, AI agent orchestrator 400 may define (at step 412) actions to schedule an in-person meeting with one or more of the healthcare professionals to discuss the specific medicine, to generate a presentation with the latest studies about the effectiveness and/or efficacy of the specific medicine, and to invite the one or more healthcare professionals to attend an upcoming seminar discussing treatment options for the particular ailment. The signal evaluation (at step 410) for a different customer or potential customer may reveal that the customer is using a competitor's medicine and has declined in-person meetings with sales representatives of the manufacturer. Accordingly, the set of actions may include generating a personalized email marketing campaign with specialized pricing that undercuts the competitor's pricing and that highlights advantages of the offered medicine over the competitor's medicine.

The set of actions may be selected from an actions library. The actions library may be based on configurable tasks that a second set of AI agents 403 are trained to perform. In particular, a defined (at step 412) action may include configuring the task of a specific AI agent for a desired outcome that advances or satisfies part of the high-level objective or workflow.

AI agent orchestrator 400 selectively invokes (at step 414) different subsets of second set of AI agents 403 to perform the defined (at step 412) set of actions for each customized instance of the objective or workflow. Each AI agent of second set of AI agents 403 is configured or trained to perform a specific task. Selectively invoking (at step 414) the different subsets of second set of AI agents 403 may include generating the prompts that configure the tasks of a selected subset of AI agent AI agents to perform an action from a defined (at step 412) set of actions. Selectively invoking (at step 414) the subset set of AI agents may also include coordinating or controlling the execution order of the subset of AI agents such that the outputs of one or more AI agents may be used as input by another AI agent. For instance, some of the defined (at step 412) actions may include dependencies that prevent one action from executing before another action executes or that requires the output of one or more actions as inputs for another action. AI agent orchestrator 400 accounts for these dependencies when selectively invoking (at step 414) the different subsets of AI agents to ensure that the set of actions advances or progresses through the objective sequentially rather than perform different steps or stages of the objective simultaneously or independently.

AI agent orchestrator 400 creates a dynamically reconfigurable distributed computing environment with scalable compute complexity based on the selective invocation (at step 414) of second set of AI agents 403. In particular, the compute complexity associated with each objective or workflow instance changes based on the different actions that are defined (at step 412) to implement the outcome or end result of that objective or workflow instance. Rather than allocate compute resources separately for each objective or workflow instance or train a single AI agent to perform all aspects of a particular objective or workflow instance, AI agent orchestrator 400 reuses the compute resources already allocated to the deployed AI agents (e.g., first set of AI agents 401 and second set of AI agents 403) to scale the existing compute complexity for the different objective or workflow instances.

AI agent orchestrator 400 and the AI agent 403 orchestration may be used to simultaneously execute or perform hundreds, thousands, or more of the objective or workflow instances using the same compute resources. The parallelized execution of numerous objective or workflow instances further scales the distributed computing environment compute complexity by preventing the compute resources and/or AI agents 403 from being dedicated or locked to one objective or workflow instance during the execution of that single objective or workflow instance. In fact, there may be no practical limit on the number of simultaneous objective or workflow instances that may be orchestrated by AI agent orchestrator 400 so long as there is an open window for selectively activating the required AI agents 403. Accordingly, for an organization with a vast customer pool (e.g., hundreds, thousands, or millions of customers and potential customers), AI agent orchestrator 400 may orchestrate the parallelized execution of a different objective or workflow instance for each customer in the customer pool through the shared and selective execution of the same set of AI agents 403 without allocating new or additional compute resources or AI agents 403 for each customer or each objective or workflow instance. The orchestration is rooted computer networking and distributed computing as it enables one system or entity (e.g., AI agent orchestrator 400) to coordinate and control the execution of the objective and workflow instances for numerous targets.

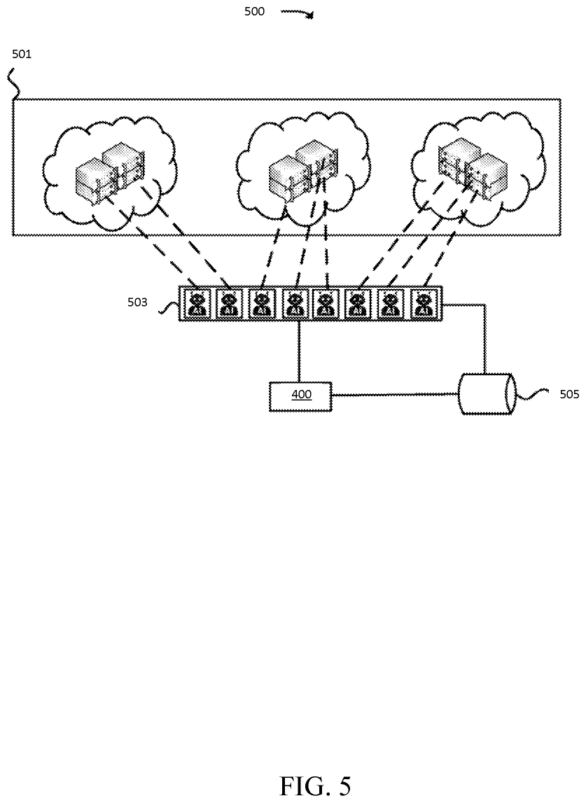

FIG. 5 illustrates an example architecture 500 with scalable and adaptable compute complexity for implementing different objectives or workflows in accordance with some example embodiments presented herein. Architecture 500 includes AI agent orchestrator 400 (e.g., orchestrator 170) and distributed compute resources 501 that are configured to run different AI agents 503, and repository 505.

AI agent orchestrator 400 runs on one or more devices or machines of a client or on compute nodes of distributed compute resources 501. In some example embodiments, AI agent orchestrator 400 is embedded within other systems of the client. For instance, AI agent orchestrator 400 may be integrated within a CRM platform or system of the client. The CRM system may provide contact management, sales management, marketing automation, customer support management and tracking, and reporting. The marketing automation may include the automatic sending of email marketing campaigns as an example of a single automated task. Integration of AI agent orchestrator 400 into the CRM system extends and enhances the CRM automation so that automation is not performed solely on isolated and independent tasks but on entire objectives or workflows that are each defined with multiple tasks that may be dependent on one another.

AI agent orchestrator 400 is an agentic controller of AI agents 503. AI agent orchestrator 400 receives an objective or workflow that is defined with a desired outcome or end result, determines the different sets of actions that produce the desired outcome or end result given different input signals, and selectively activates different sets of AI agents 503 to generate the desired outcome or end result.

In some example embodiments, AI agent orchestrator 400 is configured with a signals library and/or an actions library. The signals library may specify lists of relevant signals for different objectives or workflows and/or define an impact of a relevant signal to the objective or workflow. For instance, the signals library may identify keys from key-value pairs that have relevance to specific objectives or workflows. The actions library may specify the different actions that may be performed using AI agents 503. The actions library may include links, identifiers, and/or formatting requirements for configuring each the AI agent task to perform a specific action and for calling and/or executing the AI agent. In some example embodiments, AI agent orchestrator 400 scans compute resources 501 to discover AI agents 503 and populate the actions library based on metadata or other information that identifies the task performed by each discovered AI agent 503. In some other example embodiments, the actions library is updated as each AI agent 503 is defined and deployed to compute resources 501.

In some example embodiments, AI agent orchestrator 400 is configured with rules for evaluating the signals and/or for mapping the signal evaluation to different actions. In some such example embodiments, AI agent orchestrator 400 models the rules based on active usage of a client system or by monitoring activity related to a configured objective or workflow. In some other example embodiments, the rules may be defined by a system administrator. The rules may include constraints.

The constraints may restrict the frequency with which actions are performed. For instance, a constraint may limit the number of emails or other communications that may be sent to a targeted entity in a given time frame. Other constraints may restrict the actions themselves. For instance, an action may include scheduling an in-person meeting. The constraint may limit the number of in-person meetings that may be scheduled in a day (e.g., maximum of 8) or limit other communications to a targeted entity when an in-person meeting has been scheduled (e.g., no marketing emails within a week of a scheduled in-person meeting). The constraint may be set based on customer preferences or obtained from a profile associated with a given customer.

AI agent orchestrator 400 uses the signals, rules, and/or constraints to orchestrate the execution of AI agents 503 and, in doing so, leverages compute resources 501 running AI agents 503 to create a distributed computing environment with dynamically reconfigurable and scalable compute complexity. In some example embodiments, AI agent orchestrator 400 communicates and/or controls AI agents 503 using the Model Context Protocol (MCP) or another protocol for standardized communications between AI agent orchestrator 400 and different AI agents 503.

Distributed compute resources 501 include devices, machines, or nodes of a client, third-party partner of the client, and/or one or more cloud computing service providers. AI agents 503 running on distributed compute resources 501 may be deployed and operated by different entities. Distributed compute resources 501 include processor, memory, storage, network, and/or other hardware resources that may be configured to perform the different siloed tasks associated with each AI agent 503.

Since each AI agent 503 is trained to perform a specific task, each AI agent 503 may represent a specialized autonomous system that generates specific output based on specific prompts and/or input signals. The training may enable each AI agent 503 to interface with a different data source or system in order to perform the specific task via manipulation or interaction with that data source or system.

In some example embodiments, AI agents 503 support a data package protocol for inputting signals into AI agent orchestrator 400. These AI agents 503 may reformat, correct, or otherwise modify data that is collected from different data sources to conform with a signal format defined in the data package protocol. For instance, AI agents 503 may receive data from the different data sources and may structure the data in a JavaScript Object Notation (JSON) or other extensible format. The JSON or other extensible format may be used to represent the signals as key-value pairs where the key identifies the signal type and the value specifies the data for the signal type.

The data sources may include internal and external data sources. The internal data sources may store data that is generated or input into the CRM system by representatives or agents of an AI agent orchestrator 400 client. The external data sources may include data that is generated by customers of the AI agent orchestrator 400 client, by third-parties that track customer activities, or by other third-parties that generate data that is relevant to the activities of the third-parties.

Other AI agents 503 are trained or configured to perform actions for advancing or progressing through different stages of an objective or workflow. The tasks may include scheduling in-person, telephony, or virtual meetings, sending machine-generated communications to the client's customers (e.g., emails, instant messages, text messages, etc.), generating customized presentations for the client's customers, providing AI-generated coaching or instruction to the client's representatives, generating and executing customized engagement plans, shipping samples to the client's customers, monitoring and tracking representative activities, lead generation, reviewing and summarizing content for the client's customers, and/or performing other autonomous actions that fulfill or complete different stages or phases of different objectives or workflows.

AI agent orchestrator 400 directs the dynamic AI agent orchestration based on signals that are received for an objective or workflow defined by a particular client and the evaluation of those signals. The signals correspond to data that is temporally and contextually relevant to the particular client and/or the objective or workflow. In some example embodiments, the signals may be used to create different instances of the same objective or workflow. For instance, AI agent orchestrator 400 may create a different instance of the objective or workflow for each customer of the particular client, for each product or service of the particular client, and/or other instance designations (e.g., for each patient, for each student, for each sales cycle, for each business day, etc.). The signals may also contain preferences of the particular client and may cause AI agent orchestrator 400 to adjust the actions that are performed by AI agents 503 to accommodate the preferences. Different signals may be generated at different times such that the signal data may vary over time for the same client or a given objective. A signal may also be derived from one or more other signals. For instance, a signal may be a summary or a collection of relevant data from other signals or machine-accessible content. The derived signals may be determined by an external team (e.g., a data science team) or by AI agents 503 that are tasked with preprocessing data that is collected from one or more data sources.

AI agent orchestrator 400 performs the signal evaluation to determine the impact that each signal has on the objective or workflow. Based on the signal evaluation, AI agent orchestrator 400 adjusts the actions that a dynamically selected set of AI agents 503 execute. In other words, repeated execution of the same objective or workflow may include different actions performed by different sets of AI agents 503 based on the evaluation of the available signals when executing the objective or workflow.

In one implementation, AI Agents 503 may include a preparation agent, a content agent, unstructured text agent, and voice agent. The preparation agent may assist a user (e.g., pharmaceutical representative) in pre-communication planning with a client (e.g., health care professional) by searching the approved content repository for relevant materials, summarizing findings or previous interactions, and ensuring only compliant information is presented.

In one aspect, the preparation agent assists users (e.g. pharmaceutical representatives) to prepare for upcoming conversations with a health care professional (HCP). The preparation agent may search the approved content repository for relevant materials, summarize findings or previous interactions, and ensure that compliant information is presented. The preparation agent may combine context, opportunities, and actions for a specific account. The preparation agent may present information in a chat user interface, leading to more targeted conversations, improved customer engagement, and enhanced field productivity.

Users such as pharmaceutical representatives may rely on a combination of different data to drive topics of conversation for an upcoming interaction. The different data may include recent interaction data, account preferences, prescribing trends, account suggestions, and open call objectives. The preparation agent may aggregate and synthesize the different data to provide a consolidated view of relevant information prior to an HCP interaction.

In some implementations, the preparation agent may operate at two levels. A first level may comprise an account level preparation agent that aims to provide a pharmaceutical representative with a quick overview of information to know about an HCP prior to having an interaction with the HCP. A second level may comprise a representative level preparation agent that aims to surface information and tasks for the pharmaceutical representative to address while planning the representative's day.

The account level preparation agent may include a toolkit of functions for retrieving account-specific information. The toolkit may include a function to get multichannel customer contact plan (MCCP) performance data. The toolkit may include a function to get a recent call with the representative. The toolkit may include a function to get a most recent call with the HCP. The toolkit may include a function to get medical inquiries associated with the account. The toolkit may include a function to get sample requests from the HCP. The toolkit may include a function to get product metrics related to the account. The toolkit may include a function to get suggestions for the account. The toolkit may include a function to get content relevant to the account from the controlled content repository.

In some implementations, the preparation agent may capture context based on the user's position in the workflow. For example, when a user is on a map user interface preparing and researching for a call with an HCP, the position of the user in the workflow, as well as which account or appointment the user is viewing, may be captured and passed to a large language model (LLM). The context capture may eliminate the need for additional filtering or querying to obtain relevant information. A real-time updated set of interactions may be retrieved for the HCP, such as past activity within a specified time period.

The preparation agent may search the controlled content repository using a retrieval-augmented-generation (RAG) flow to identify relevant materials for the upcoming interaction. The preparation agent may summarize findings from the controlled content repository and provide the summaries to the user with links to the controlled content repository as reference. The links may increase trust and allow the user to verify answers provided or obtain additional information from supporting documentation.

The preparation agent may enforce security and visibility rules throughout the pre-call planning process. The preparation agent may access content and customer relationship management (CRM) data within the user's authorized scope. The preparation agent may use approved content aligned with the respective user that has passed medical, legal, and regulatory (MLR) review. Content that has not passed the MLR review process, and content that the user does not have access to, may not be used by the preparation agent.

A context-aware orchestration agent may assess what context to pass to AI agents based on a user's current position in an application or navigation history of the user. The context-aware orchestration agent may dynamically determine the context that is relevant to AI agents based on the user's location within a workflow management application. The context-aware orchestration agent may capture context information and pass the context information to AI agents to enable the AI agents to provide relevant responses and perform relevant actions.

In some implementations, the context-aware orchestration agent may track the user's position within the application using cookies or other tracking mechanisms sent to a server. The tracking may identify which screen, page, or workflow step the user is currently viewing. The context-aware orchestration agent may use the tracked position to determine which data and context to retrieve and pass to AI agents.

The context-aware orchestration agent may provide different context to AI agents based on the type of page or workflow step the user is accessing. When a user is in a call report, the context-aware orchestration agent may provide a list of restricted products, allowed products, and segmentation information for all accounts on the call. When a user is on an account page, the context-aware orchestration agent may provide a list of restricted products, allowed products, and segmentation information for the account being viewed. The context-aware orchestration agent may adapt the context provided to AI agents based on the specific workflow context of the user.

Product alignment may be performed based on restricted products, allowed products, and account segmentation checks. The context-aware orchestration agent may retrieve product alignment information from a customer relationship management (CRM) database and provide the product alignment information to AI agents. The product alignment information may enable AI agents to determine which products the user is authorized to discuss with specific accounts and which products are restricted for specific accounts.

Restricted products may comprise products that a user is prohibited from discussing with a particular account. The restrictions may be based on regulatory requirements, account preferences, or organizational policies. Allowed products may comprise products that a user is permitted to discuss with a particular account. The context-aware orchestration agent may cross-reference products mentioned in user inputs against restricted products lists and allowed products lists for call accounts, locations, and attendee accounts.

Account segmentation checks may comprise verification that the user is authorized to access and interact with a particular account based on segmentation rules. The segmentation rules may define which users or user types are permitted to engage with specific accounts or account categories. The context-aware orchestration agent may enforce account segmentation rules by providing AI agents with segmentation information that restricts the scope of actions and content available for a given account.

In some implementations, the context-aware orchestration agent may capture context based on the user's position in a pre-call planning workflow. When a user is on a map user interface preparing and researching for a call with a healthcare professional (HCP), the context-aware orchestration agent may capture the position of the user in the workflow as well as which account or appointment the user is viewing. The captured context may be passed to a large language model (LLM) without requiring additional filtering or querying to obtain relevant information. A real-time updated set of interactions may be retrieved for the HCP, such as past activity within a specified time period.

The context-aware orchestration agent may be pervasive within the user interface. Wherever the user is in the user interface, an AI agent icon may be visible and accessible at a designated location on the screen, such as the bottom right corner. Depending on where the user is in the application and what part of the workflow the user is in, context may be captured and passed to the context-aware orchestration agent for distribution to AI agents.

The context-aware orchestration agent may use structured data to dynamically select and combine relevant advisor prompts based on user context and object type. The dynamic selection may apply correct compliance frameworks and regulatory requirements based on the user's context. The context-aware orchestration agent may retrieve user type, user country, CRM settings, and object or field metadata to determine which compliance checks to run and which context to provide to AI agents.

The context-aware orchestration agent may enforce security and visibility rules when providing context to AI agents. The context-aware orchestration agent may access content and CRM data within the user's authorized scope. Content that has not passed a medical, legal, and regulatory (MLR) review process, and content that the user does not have access to, may not be provided to AI agents by the context-aware orchestration agent.

In another aspect, the unstructured text agent automatically and dynamically examines free text for compliance and regulatory rule violations. The unstructured text compliance agent may use a compliance model to detect non-compliant content in free-text entries authored by users within workflow management applications. The compliance model may be implemented as a large language model (LLM) or similar artificial intelligence model configured to analyze user-authored free-text entries in call reports or other workflow management applications.

In some implementations, the unstructured text compliance agent may use approved content aligned with a respective user (e.g., pharmaceutical representative) as context for compliance analysis. Content that has not passed a medical, legal, and regulatory (MLR) review process, and content that the user does not have access to, may not be used by the unstructured text compliance agent. The restriction to MLR-approved content may ensure that compliance determinations are based on verified and authorized reference materials rather than general training data or external sources.

Models 160 (e.g., the compliance model, or neural-network based classifier) may be conditioned with prompt context comprising regulatory rules, approved reference language, and product-specific standard operating documents. The prompt context may include a standard operating document specifying compliance rules and regulations, such as prohibitions on protected health information (PHI), personally identifiable information (PII), and off-label messaging. The compliance model may analyze free-text entries to identify non-compliant content, including off-label messaging, PHI, or PII. For example, an example off-label messaging may include talking about a cancer drug or indication that it is not FDA approved to do. Off-label messaging may be product-specific. The unstructured text agent may execute semantic search through related content from the approved content repository 102 and stored in vector database 184 to identify any product facts in the free text that are not in the supporting documentation regarding the product.

In one implementation, AI Agent 503 may always cite the source slide for any information that it provides. This extra layer of information provides assurance and quality protection that the AI agent response is factual and correct. The alignment and compliance of the content may be based on restricted products, allowed products, and account segmentation checks.

The orchestration agent may intelligently and dynamically assess what context to pass to the AI agent. For example, based on the user's current position in the application or their navigation history, certain context is passed to the AI agent. If the user is in a call report, then the list of Restricted Products, Allowed Products, and Segmentation for all Accounts on the Call is provided. Similarly, if the user is on an Account page, the list of Restricted Products, Allowed Products, and Segmentation for all Accounts is also provided.

Off-label messaging may be product-specific. For example, off-label messaging may include discussing a drug or indication that is not approved by a regulatory authority. The compliance model may detect off-label messaging based on product-specific approved indications stored in the controlled content repository.

The unstructured text compliance agent may execute a semantic search through related content in the approved content repository to identify product facts in the free text that are not present in supporting documentation regarding the product. The semantic search may be performed using a retrieval-augmented-generation (RAG) flow against the controlled content repository to obtain reference passages related to identified compliance concerns. The RAG flow may compare user text against approved reference language and identify divergences between the free-text entry and the retrieved reference passages.

Upon detecting non-compliant content, the unstructured text compliance agent may automatically generate remedial actions. The remedial actions may include visually highlighted divergent segments within a user interface and proposed compliant replacement text. The unstructured text compliance agent may present the remedial action and a summary of the retrieved reference passages with links to the controlled content repository to the user for review. The links may allow the user to verify the compliance concern and obtain additional information from supporting documentation.

Upon user acceptance of a proposed replacement, the unstructured text compliance agent may update the free-text entry in the workflow management application with the accepted compliant replacement text. The unstructured text compliance agent may write an immutable audit record to the controlled content repository linking the original entry, the remedial action, the accepted replacement, and a timestamp. The audit record may further include a user identifier and a cryptographic hash of the accepted compliant replacement text.

In some cases, when the user rejects the proposed compliant replacement text, the unstructured text compliance agent may present additional supporting documentation from the controlled content repository to the user. The additional supporting documentation may provide further context for the compliance concern and assist the user in understanding the basis for the flagged content. AI agents may cite the source document for information provided to users. When an AI agent provides information in response to a user query or as part of a compliance analysis, the AI agent may include a reference to the source document from which the information was obtained. The source citation may provide an additional layer of assurance and quality protection that the AI agent response is factual and correct. The source citation may enable users to verify the accuracy of information provided by the AI agent and to obtain additional context from the referenced documentation.

In some implementations, supporting documentation identified by a large language model (LLM) may be summarized and provided to users with links to the controlled content repository 102 as reference. The links may increase trust and allow users to verify answers provided or obtain additional information from the supporting documentation. The source citations may reference specific documents, sections, or passages within the controlled content repository that support the AI agent's response or analysis.

Advisor prompts provided to the LLM may include instructions for knowledge boundary enforcement. The knowledge boundary enforcement instructions may prevent the LLM from relying on general product or medical knowledge instead of information provided in reference documents or compliance documents. The advisor prompts may instruct the LLM to cite the specific tool or document source for any claim made during compliance analysis or response generation.

In some cases, when context required to perform an analysis is not available through provided tools, the LLM may not make assumptions. Unavailable context may include missing prescribing information (PI) documents, missing country information, or documents that do not contain relevant information. When the required context is unavailable, the LLM may state that context is not available and may not flag any text for compliance concerns. The LLM may refuse to flag text based on general medical knowledge when specific reference documents are not available.

The knowledge boundary enforcement may ensure that compliance determinations are based on verified and authorized reference materials rather than general training data or external sources. For promotional compliance checks, the advisor prompts may instruct the LLM to look for PI type reference documents and use the PI type reference documents as the basis for analysis of off-label claims. In cases where PI type reference documents do not exist, the LLM may not use general training or access to product labels on the internet to perform the analysis and may not flag any off-label information.

The advisor prompts may include instructions for the LLM to explain the rationale for each assessment. The LLM may provide a rationale that explains the basis for compliance determinations, enabling human reviewers to understand and verify the reasoning behind flagged content. The advisor prompts may further include instructions for the LLM to generate a confidence interval with a score indicating the certainty of the LLM's findings. The confidence score may range from a low value indicating a response that lacks grounding in provided reference materials to a high value indicating a response that is well-reasoned and grounded in facts based on the advisor prompt's instructions.

The prompt context provided to the compliance model may be aligned with products and accounts associated with the user. The alignment may ensure that compliance analysis is performed using reference materials relevant to the specific products and accounts that the user is authorized to discuss. The unstructured text compliance agent may enforce security and visibility rules throughout the compliance checking process, accessing content and customer relationship management (CRM) data within the user's authorized scope.

In another aspect, a voice agent may automatically create call reports documenting interactions with healthcare professionals (HCPs). The voice agent may receive audio input from a user via a voice recording interface of a customer relationship management (CRM) application. The audio input may comprise a dictated description of an interaction with an HCP. The voice agent may generate a transcript from the audio input using a speech transcription engine executing locally on a mobile device.

In some implementations, the voice agent may store the audio input and the transcript exclusively in local storage of the mobile device. The audio input and the transcript may not be transmitted to a remote server during the recording and transcription process. The local storage approach may provide data protection by preventing transmission of raw audio recordings containing sensitive healthcare interaction details to external systems.

The voice agent may transmit the transcript to an artificial intelligence (AI) orchestration layer to extract a plurality of call record fields from the transcript. The AI orchestration layer may analyze the transcript to identify various data elements for populating the call record. The call record fields may include an account identifier determined by matching name references in the transcript against account records stored in a CRM database. The matching may compare name references against name fields, formatted name fields, and phonetic name fields of the account records.

In some cases, when the matching identifies a plurality of candidate accounts, the voice agent may present an account selector interface listing the plurality of candidate accounts for user selection. The account selector interface may display suggested accounts above a list of all accounts, wherein the suggested accounts comprise top values returned by the AI orchestration layer. The user may search accounts and select an appropriate account from the displayed options.

The call record fields may further include a datetime or date determined from temporal references in the transcript. The AI orchestration layer may determine when the meeting took place based on context in the transcript. The call record fields may further include a communication channel determined from the transcript, wherein the channel may include in-person, video, phone, email, text message, or other communication methods. The call record fields may further include one or more products discussed during the interaction, wherein extracting the one or more products discussed comprises matching product references in the transcript against product records associated with the user. The call record fields may further include one or more follow-up tasks, wherein extracting the one or more follow-up tasks comprises identifying task descriptions, assignees, and due dates from the transcript.

The voice agent may automatically populate a call record with the extracted call record fields. The voice agent may present the populated call record to the user via a user interface of the CRM application for validation. The user may review and edit the populated fields before saving or submitting the call record.

The voice agent may perform security checks prior to initiating a voice recording session. The voice agent may automatically close when a restricted account is accessed. When a user attempts to dictate a call voice note for a restricted account, the voice agent may display an error message and close the AI button menu. Restrictions may include do-not-call designations and accounts for which the user does not have permission to create call records.

The voice agent may support different pronunciations through a voice dictionary. The voice dictionary may store voice dictionary entries comprising a phrase, a pronunciation, a language, and a country. When a user speaks a word matching the pronunciation value of a voice dictionary entry, the voice agent may substitute the corresponding phrase in the generated transcript. The voice dictionary may include a default dictionary as well as a custom dictionary defined in customer preferences or a profile extracted from the CRM. The custom pronunciation support may enable accurate transcription of pharmaceutical product names, medical terminology, and HCP names that may have non-standard pronunciations.

In some implementations, the voice agent may identify follow-up activity sections within the transcript based on trigger phrases. The trigger phrases may indicate the beginning of a follow-up task section in the dictated content. The voice agent may extract follow-up task information including task descriptions, assignees, and due dates from the identified sections.

The voice agent may provide pause and resume functionality during voice note recording. The user may pause the audio recording and transcript generation, and subsequently resume recording. The voice agent may also provide a discard option that permanently deletes the audio and transcript when selected by the user.

In some implementations, the voice agent may save a voice note for later processing. When the user selects a save-for-later option, the voice agent may create a temporary record on the mobile device with the audio and transcript associated with the temporary record. The temporary record may store the datetime, the voice note type, and the account context. The temporary record may persist through a database refresh. Saved voice notes may display as events in a schedule view of the CRM application, allowing the user to reconcile the voice notes at a later time.

Once the call report is generated and submitted, the voice agent may automatically delete the associated audio and recorded transcript from the local storage of the mobile device. The deletion may occur without displaying a confirmation prompt to the user. The automatic deletion may provide compliance with data protection requirements and automated protection of sensitive data. The audio input and the transcript may be deleted in response to receiving a submission of the call record by the user.

In some implementations, during a synchronization operation with a remote server, the voice agent may automatically delete the audio input and the transcript from the local storage in response to detecting that the call record has been updated to a submitted status during the synchronization operation. The voice agent may also automatically delete the audio input and the transcript from the local storage in response to detecting that the call record has been deleted during the synchronization operation. The synchronization-based deletion may ensure that audio and transcript data is removed from the local device when the associated call record is modified or removed on another device or through another interface.

The voice agent may operate in conjunction with a compliance monitoring agent. After the voice agent populates the call notes field from the transcript, the compliance monitoring agent may analyze the call notes for compliance with regulatory requirements. The compliance monitoring may be performed by a separate compliance agent rather than by the voice agent itself.

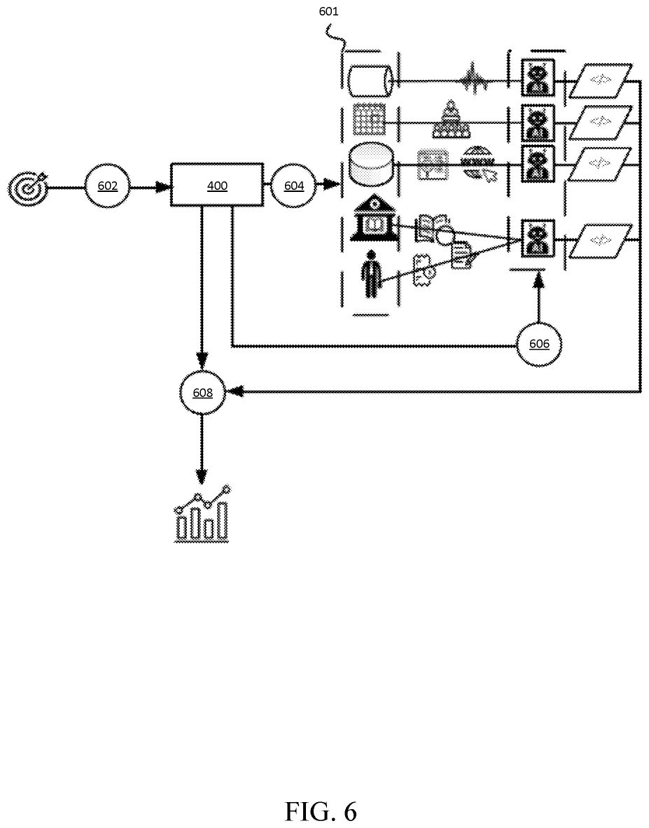

FIG. 6 illustrates an example of the signal collection driving the selective and collaborative AI agent orchestration in accordance with some embodiments presented herein. AI agent orchestrator 400 is configured (at step 602) with one or more objectives or workflows to autonomously implement on behalf of a particular client. The one or more objectives or workflows may be defined at a high level or with specific granularity. For instance, a high-level objective may specify “increase sales” and a more granular objective may specify “increase sales of offered pharmaceuticals for specific indications in defined territories or regions”.

AI agent orchestrator 400 connects (at step 604) to different data sources 601. Data sources 601 may be identified or configured by a client that uses AI agent orchestrator 400 for the objective or workflow automation. The client may configure AI agent orchestrator 400 with access to the different data sources 601. For instance, the client may have access to different databases or data repositories that store different types of signals and may configure an account or provide credentials with which AI agent orchestrator 400 may access the different databases or data repositories. Data sources 601 may include internal or client-controlled data sources, publicly accessible data sources, or external third-party data sources that are not controlled by the client. Examples of data sources 601 include a CRM system (e.g., tracking customer engagements), PromoMats (e.g., managing promotional content in the life sciences industry by connecting promotional and medical data), Medcomms (e.g., creating, managing, and disseminating accurate and compliant scientific information to stakeholders like healthcare professionals, researchers, and patients), online activity trackers, conference or seminar registration data, conference and/or meeting recordings, anonymized patient or customer data, regulatory and compliance management systems, clinical trial data, efficacy data, and/or other forms of digital information that are accessible over a data network.

In one implementation, AI agent orchestrator 400 may connect only approved data sources. Approved data sources (e.g., controlled content repository 102) may include content satisfying the completion of medical, legal and regulatory review for ensuring marketing and promotional materials are accurate, compliant with relevant laws and regulations (e.g., Food and Drug Administration guidelines), and ethically sound before being released to the public. Connecting only approved data sources solves a known problem in the art of hallucinations. By controlling and restricting the information used by the models and agents to only data sources satisfying MLR review, only approved and factually accurate and compliant answers are provided.

A data source 601 may include a controlled content repository designed to have a process for developing approved content that is sharable across multiple users, such as shareholders, reviewers, managers, marketing personnel, sales representatives, etc. The content generated in the controlled content repository may be accessed on a regulated basis and used to generate approved electronic communications. This regulated basis may be determined, in part, by the company as a whole and additionally by interaction with data from the CRM system, described in further detail below. In one embodiment, approved content, customer profile information, customer preferences, and regulatory limitations and requirements may be stored in a table in the controlled content repository. In addition to storage and development of content, the controlled content repository may also store an audit trail, tracking exact content of communications as they were sent by the user (e.g. pharmaceutical rep), as well as metadata about the communications and information regarding the content accessed by recipients (e.g. health care professional, or HCP).

The CRM system contains all professional information of HCPs that may be available to users, including contact information, licensing information, areas of practice, and specialties. In addition, the CRM system may also be capable of storing configurations regarding specific preferences, regulatory limitations and requirements, and other fields that will facilitate the generation of appropriate approved electronic communications, in general or on a by recipient basis. These preferences and/or requirements include both the preferences of the user (e.g., maintaining account lists) as well as the preferences of the enterprise (e.g., employers of the users), discussed in further detail below. In some examples, the approved content and email templates may be pre-processed and stored in the controlled content repository. In other examples, the CRM system may have a content management subsystem and may provide the approved content and the templates.

In other examples, the CRM system may have a content management subsystem and may provide the approved content. The CRM system may access from event management 130 or store event related data, e.g., a link to approved content in the controlled content repository, a speaker list, upcoming and past event date/time/locations/topics, content associated with each event, content sharing rules allowing access to content based on speaker qualifications, contracts associated with an associated speaker, and webinar tracking information as will be described in detail below.

Within the CRM system, customer accounts may be assigned a set of alignment rules which determine specific pieces of content that are available for use from the controlled content repository. These alignment rules are applied to supply the user with a list of approved tailored email templates and pieces of content that may then be used to construct a tailored approved communication.

The tools, steps and/or operations described above in relation to an embodiment of an AI Agent of the present disclosure may occur in a different order, or in parallel, or concurrently for different epochs, etc. depending on the specific embodiment and/or implementation, as would be understood by one of ordinary skill in the art. Different embodiments may perform actions in a different order or by different ways or means or by different or multiple AI Agents. As would be understood by one of ordinary skill in the art, some drawings are simplified representations of the actions performed, their descriptions herein simplified overviews, and real-world implementations would be much more complex, require more stages and/or components, and would also vary depending on the requirements of the particular implementation. Being simplified representations, these drawings do not show other required steps as these may be known and understood by one of ordinary skill in the art and may not be pertinent and/or helpful to the present description.

Similarly, some drawings are simplified block diagrams showing only pertinent components, and some of these components merely represent a function and/or operation well-known in the field, rather than an actual piece of hardware, as would be understood by one of ordinary skill in the art. In such cases, some or all of the components/modules may be implemented or provided in a variety and/or combinations of manners, such as at least partially firmware and/or hardware, including, but not limited to one or more application-specific integrated circuits (“ASICS”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a non-transitory computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

One or more processors, simple micro controllers, controllers, and the like, whether alone or in a multi-processing arrangement, may be employed to execute sequences of instructions stored on non-transitory computer-readable media to implement embodiments of the present disclosure. In some embodiments, hard-wired circuitry may be used in place of or in combination with software instructions. Thus, embodiments of the present disclosure are not limited to any specific combination of hardware circuitry, firmware, and/or software.

AI agent orchestrator 400 activates (at step 606) one or more AI agents to perform targeted signal extraction and/or signal preprocessing. AI agent orchestrator 400 activates (at step 606) different AI agents to interface with different data sources 501 based on the type of data originating from each data source 601 and the signal extraction and/or signal preprocessing that the AI agent is configured to perform.

The targeted signal extraction may include detecting entry or generation of new data or new signals in a data source 601 that is relevant to the configured (at step 602) objectives or workflows and retrieving the new data or new signals. In some example embodiments, data sources 601 generate triggers or notifications that are passed to the one or more AI agents or AI agent orchestrator 400 when the new data or new signal is entered. In some other example embodiments, the one or more AI agents periodically scan data sources 601 for the new data or new signals. To target the signal extraction to data or signals relevant to the configured (at step 602) objectives or workflows, the one or more AI agents may identify signals that are generated based on activities of identified customers (e.g., actual and potential customers) or users associated with customers. For instance, extracting relevant signals for the objective of “increase sales of offered pharmaceuticals for specific indications in defined territories or regions” may include identifying healthcare providers and their associated representatives that practice in the medical fields associated with the specific indications and that are located in the defined territories or regions, and extracting signals that are generated based on tracked or observable activities of the identified healthcare providers or associated representatives.

The targeted signal extraction may include sorting the same signal to different objectives or workflows that are impacted by that signal. For instance, the same signal may be relevant for objectives defined at different levels. An organization may include multiple potential customers and a signal may be sorted to a first objective defined for the organization and a second objective defined for one or more potential customers within the organization.

The signal preprocessing may include converting data from different signal types to a common format. The common format may be defined in a data package protocol.

The signal preprocessing may also include filtering or deriving contextually relevant signals from unstructured, qualitative, encoded, and/or other data. For example, a first data source 601 may generate qualitative or opinion data. AI agent orchestrator 400 may activate (at step 606) one or more AI agents to perform sentiment analysis over the qualitative or opinion data and to generate a signal based on the sentiment analysis. As another example, a second data source 601 may store registration or attendance data for a particular conference or seminar. AI agent orchestrator 400 may activate (at step 606) one or more AI agents to derive a preference for a user or customer based on the registration or attendance data and the subject matter, topics, or presenters associated with the particular conference or seminar. The one or more AI agents may derive additional insights or preferences according to location tracking information or specific attendance data. For instance, if a user remained for the entirety of the particular conference or seminar, then the one or more AI agents may determine that the user has a high preference for the subject matter, topic, or presenter of the conference. However, if the user leaves early or after a particular presenter finishes presenting, the one or more AI agents may assign a lower preference to the subject matter or topic of the particular conference or seminar. Other preprocessing examples may include the one or more AI agents summarizing an audio and/or video meeting and generating signals based on salient points of the meeting that pertain to a desired objective or workflow. Similarly, the preprocessing may include analyzing related content and generating a signal with relevant data that is extracted from the related content.

AI agent orchestrator 400 evaluates (at step 608) the signals that are received from data sources 601 and/or the AI agents performing the signal extraction and the signal preprocessing. The signal evaluation (at step 608) determines an importance of each signal to the configured (at step 602) objective or workflow. AI agent orchestrator 400 dynamically generates and executes different sets of actions through the selective invocation of AI agents in the distributed computing environment based on the signal evaluation.

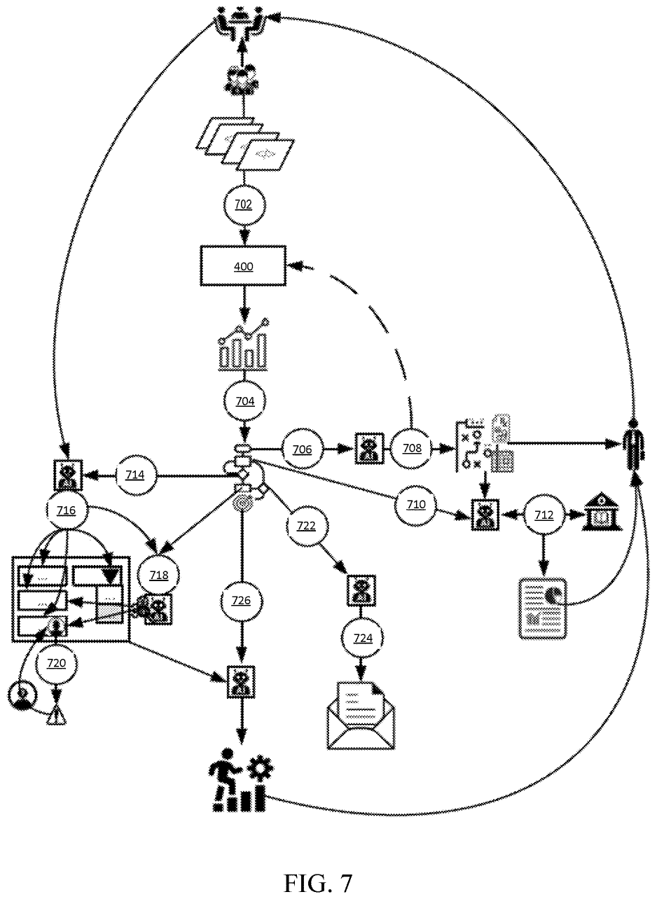

FIG. 7 illustrates an example of orchestrating the dynamic activation of AI agents to complete custom actions for executing an objective or workflow instance in accordance with some example embodiments presented herein. AI agent orchestrator 400 is configured to automate the objectives or workflows of a client. In this example, the objectives or workflows may include automating various aspects of a user associated with the client in order to increase sales to customers.

AI agent orchestrator 400 receives (at step 702) signals associated with a particular customer that is assigned to the user (e.g., sales representative). AI agent orchestrator 400 defines (at step 704) a custom set of actions to implement the objective or workflow based on an evaluation of the signals.

AI agent orchestrator 400 dynamically activates a custom set of AI agents to perform the custom set of actions. AI agent orchestrator 400 activates (at step 706) a first AI agent that performs an engagement planning task at a first time. Activating (at step 706) the first AI agent may include configuring the first AI agent to customize the engagement planning task for a particular defined action of the objective or workflow. In particular, AI agent orchestrator 400 may configure the first AI agent based on the signal evaluation preferences for the targeted customer that may be determined from the received signals, and/or defined constraints for customer engagement.

The first AI agent generates (at step 708) a customized engagement plan for the user to engage the particular customer. In some example embodiments, the first AI agent generates (at step 708) the customized engagement plan by analyzing past engagements with the particular customer to determine the preferred engagement format (e.g., in-person meeting, virtual meeting, email communications, text messages, etc.), frequency of engagement (e.g., once a month, once a quarter, etc.), and/or time and place for the preferred engagement format. The first AI agent may access the user's calendar to schedule a meeting according to the preferred engagement format and to send an invitation or meeting notice to the particular customer. The first AI agent may notify AI agent orchestrator 400 when the action is complete. The first AI agent may provide the engagement plan and/or confirmation of the schedule meeting to AI agent orchestrator 400 as part of the notification.

Prior to the start of a scheduled call, communication, or meeting, AI agent orchestrator 400 may activate (at step 710) a second AI agent that performs a content screening task at a second time that is after the first time. Activating (at step 710) the second AI agent may include providing the engagement plan generated (at step 708) by the first AI agent to the second AI agent and configuring the second AI agent to customize the content screening task for a particular product that is the subject of discussion in the scheduled call, communication, or meeting.

The second AI agent analyzes (at step 712) different content for temporal and contextual relevance to the particular product. The second AI agent prioritizes recently published content that describes advantages or benefits of the particular product, answers questions about the particular product, and/or otherwise assists in the sale or promotion of the particular product. The contextual relevance may be determined based on content discussed in other meetings that produced positive sales outcomes for the particular product. The contextual relevance may also be determined based on the received signals that track the particular customer's activities relating to the particular product or a need addressed by the particular product. For instance, the received signals may identify that the particular customer has researched or reviewed past publications about the particular product. Accordingly, the second AI agent may prioritize a more recent publication about the particular product. Similarly, the received signals may indicate that the particular customer has called technical support with questions about a feature of the particular product and the second AI agent may prioritize training materials on the feature or other uses of the feature.

The second AI agent generates (at step 714) modified content based on the content analysis (at step 712). The modified content may include a machine-generated summary or bulleted list of key points of the prioritized content. In some example embodiments, the prioritized content may provide the user with a summary or notes of past communications that the user has had with the particular customer, a review of the user's performance with respect to the particular customer against their plan, and/or goals to accomplish during the call, communication, or meeting. Moreover, the second AI agent may provide an interface with which the user may obtain additional data about the particular customer or the particular product being offered that is within the modified content. The second AI agent may include a chatbot that the user may interact with using voice or text, and the chatbot may generate answers or provide relevant content in response to the interactions.

In some example embodiments, the second AI agent monitors the call, communication, or meeting in real-time in order to provide relevant content in real-time. For instance, the second AI agent may present content that answers questions posed by the particular customer in real-time and/or provide recommendations based on modeled best practices to improve the outcome (e.g., spending too much time on a feature, talking too fast, engage the customer with a question, etc.).

At the conclusion of a call, communication, or meeting, AI agent orchestrator 300 may activate (at step 714) a third AI agent to generate (at step 716) a meeting report. The third AI agent may automatically populate certain fields of the meeting report to identify the meeting participants, log the meeting time and place, and/or generate notes from monitoring the meeting audio. The third AI agent may also receive meeting notes from the user as text or as an audio. Based on the machine-generated notes or the user provided notes, the third AI agent may activate other AI agents.

The third AI agent may activate (at step 718) a fourth AI agent that detects (at step 720) and/or corrects compliance violations in the generated meeting notes. For instance, the fourth AI agent may identify PII or other private or confidential information in the meeting notes and may remove or replace the PII or other private or confidential information to avoid a compliance violation.

AI agent orchestrator 300 may activate (at step 722) a fifth AI agent in response to the meeting report containing actionable items or in response to various outcomes being recorded in the meeting report. For instance, the meeting report may include a note to provide the particular customer with requested follow-up information. The fifth AI agent may retrieve the requested follow-up information, generate an email with the follow-up information, and submit (at step 724) the email to the particular customer upon verification by the user. Additionally, the fifth AI agent may perform other post-meeting actions including scheduling a follow-up meeting, updating the engagement plan or the executed objective or workflow in response to the completed meeting satisfying or advancing a specific part of the objective or workflow, submitting orders for the particular product, and/or other actionable items that are listed in the meeting report.

AI agent orchestrator 400 may activate (at step 726) a sixth AI agent to provide AI-generated coaching to the particular sales representative and/or other sales representatives. The sixth AI agent may analyze the meeting report and/or recorded meeting audio relative to modeled best practices and may identify changes that may improve future outcomes. The sixth AI agent may generate the modeled best practices from analyzing meeting reports and meetings of other sales representatives with high success rates or positive outcomes.

In some example embodiments, AI agent orchestrator 400 may generate a dynamic user interface for visualizing the signal evaluation and/or the custom set of actions that are defined based on the signal evaluation. The dynamic user interface allows a system administration to drill-down into the AI agent orchestrator 400 automated decision-making and/or adjust rules, constraints, and/or other configuration parameters of AI agent orchestrator 400.

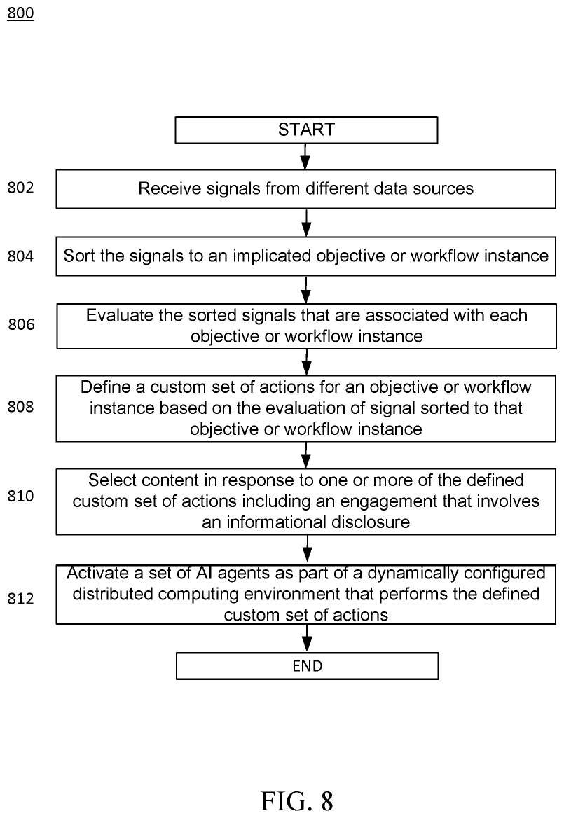

FIG. 8 presents a process 800 for dynamically generating actions based on the signal evaluation in accordance with some example embodiments presented herein. Process 800 is implemented by AI agent orchestrator 400.

Process 800 includes receiving (at step 802) signals from different data sources. The signals may be preprocessed by a set of AI agents in order to conform the signal data to the formatting, structure, and/or specifications of a data package protocol. The signals may also be preprocessed to remove data that is irrelevant to the configured objective or workflow and to retain, summarize, and/or present the data that is relevant to the configured objective or workflow in a machine-readable format.

Process 800 includes sorting (at step 804) the signals to an implicated objective or workflow instance. The objective or workflow may include increasing sales to customers or potential customers of a client and the signals may include tracked activities or preferences of the different customers or potential customers, non-personal data associated with different sales campaigns, and/or other data that may be used to promote sales. The sorting (at step 804) may include generating a different instance of the objective or workflow based on the grouping of the signals to the relevant customer or potential customer.

Process 800 includes evaluating (at step 806) the sorted (at step 804) signals that are associated with each objective or workflow instance. The signal evaluation (at step 806) determines or quantifies an extent by which a signal impacts the objective or workflow instance. A signal may have a positive or negative impact on the objective or workflow instance. A positive impact may be derived from a signal that indicates a desire or preference for offered products or services, for additional engagement, or an increased likelihood for future interaction. A negative impact may be derived from a signal that indicates an aversion or dislike for offered products or services, for additional engagement, or a decreased likelihood for future interaction. For instance, the signal evaluation (at step 806) for a sales objective may include determining whether a signal indicates a strong, medium, or weak interest in the offered products or services. The positive or negative impact may be measured based on sentiment associated with the signal, tracked activities that correlate to different indications of interest, and/or a proportion of signals that associated with a positive impact and a negative impact.

In some example embodiments, the signal evaluation (at step 806) generates a score for each signal. The score may represent a positive or negative contribution to the particular objective or workflow. The scoring may be based on the signals satisfying different milestones or criteria associated with the objective or workflow instance. For instance, sales prospects may be determined on whether certain signals have been received (e.g., customer treats patients with a specific indication, in-person meeting completed, informational materials sent to the customer, etc.).

In some other example embodiments, AI agent orchestrator 400 performs the signal evaluation (at step 806) based on a modeling of signal impact to other instances of the same objective or workflow. AI agent orchestrator 400 may determine that objectives or workflows that are completed with a positive disposition include a first pattern of signals and may determine that objectives or workflows that are completed with a negative disposition include a different second pattern of signals. Based on the modeling, AI agent orchestrator 400 may attribute the positive or negative impact that each signal has on the current objective or workflow.

Process 800 includes defining (at step 808) a custom set of actions for an objective or workflow instance based on the evaluation (at step 806) of signal sorted (at step 804) to that objective or workflow instance. In some example embodiments, AI agent orchestrator 400 is configured with an actions library from which to define (at step 808) the custom set of actions. The actions library may enumerate the various actions or siloed tasks that are performed by the AI agents that AI agent orchestrator 400 may orchestrate or dynamically activate.

In some example embodiments, AI agent orchestrator 400 defines (at step 808) the custom set of actions based on rules that associate individual or composite signal scores to various actions. For instance, AI agent orchestrator 400 may define (at step 808) a first set of actions in response to the composite score derived from the signal evaluation (at step 806) being in a first range, may define (at step 808) a second set of actions in response to the composite score derived from the signal evaluation (at step 806) being in a second range, and may define (at step 808) a third set of actions in response to the composite score derived from the signal evaluation (at step 806) being in a third range.

Moreover, the signal evaluation (at step 806) may identify specific preferences that may adjust which actions may be defined (at step 808) for the objective or workflow instance. For instance, the signal evaluation (at step 806) may identify negative sentiment or no user interaction with marketing emails and may identify positive sentiment or prolonged engagement with in-person visits. The signal evaluation (at step 806) may be based on personal or non-personal data (e.g., a particular customer does not respond to marketing emails or 80% of customers do not respond to marketing emails). AI agent orchestrator 400 may factor these preferences in defining (at step 808) the custom set of actions to include scheduling of in-person visits and to exclude marketing emails.

AI agent orchestrator 400 supports multi-channel orchestration such that the custom set of actions are not limited to execution through a single orchestration channel (e.g., end-user or individual-level interactions). In other words, AI agent orchestrator 400 may define and execute actions at a channel level, where each channel represents a mode of engagement or delivery mechanism for implementing an objective or workflow. The channel-level actions may include, for example, coordination of field-team activities (e.g., in-person visits, sampling programs, or event participation) and orchestration of non-personal promotional activities (e.g., automated digital campaigns, triggered content delivery, or adaptive communications through a campaign-management system). AI agent orchestrator 400 may dynamically select the appropriate channel based on the signal evaluation (at step 806) such that the same objective or workflow may trigger different actions through different channels depending on contextual or temporal factors.

Process 800 includes selecting (at step 810) content in response to one or more of the defined (at step 808) custom set of actions including an engagement that involves an informational disclosure. The content may include publications, studies, research papers, competitive analysis, pricing guides, and/or other documentation in support of the objective or workflow and/or that is specified as a dependency for a defined action. For instance, the objective may be to increase sales of a specific drug to healthcare providers and a defined (at step 808) action may be to schedule an in-person meeting to discuss advantages of the specific drug. AI agent orchestrator 400 may select (at step 810) content that includes recently published studies that support the effectiveness of the specific drug or its advantages over competitor drugs. AI agent orchestrator 400 may select (at step 810) the content based on temporal and contextual relevance to the objective or workflow and the one or more of the custom set of actions. The temporal relevance prioritizes content that has a recent publication date over older content. The contextual relevance prioritizes content that is mostly directly related to the objective or workflow being advanced or a specified action from the custom set of actions.

Process 800 includes activating (at step 812) a set of AI agents as part of a dynamically configured distributed computing environment that performs the defined (at step 808) custom set of actions. Activating (at step 812) the set of AI agents includes determining a task that is performed by each AI agent of the set of AI agents that implements part or all of an action from the defined (at step 808) custom set of actions, determining dependencies between the actions, defining an execution order for the set of AI agents that accounts for the dependencies, configuring each AI agent of the set of AI agents to adjust the executed task to parameters and dependencies associated with an action being performed by that AI agent, and invoking the set of AI agents according to the defined execution order.

In some embodiments, activating (at step 812) does not involve executing each AI agent of the set of AI agents in parallel or simultaneously. Instead, AI agent orchestrator 400 identifies that output of one or more AI agents that may serve as inputs for the action being performed by another AI agent, and may coordinate the execution of the AI agents accordingly. Moreover, AI agent orchestrator 400 configures each AI agent with a machine-generated prompt that adjusts the task that is performed by that AI agent to match one or more of the custom set of actions and to produce the output that is specified for the one or more actions. For instance, AI agent orchestrator 400 may provide selected (at step 810) content with a first prompt for a first AI agent to summarize the salient points of the content with respect to the effectiveness of a particular drug in treating a particular indication. AI agent orchestrator 700 may route the output of the first AI agent as input with a second prompt to a second AI agent that causes the second AI agent to schedule an in-person meeting with a targeted doctor at a location preferred by the targeted doctor and to provide the summarized data for a sales representative.

For each objective or workflow instance, AI agent orchestrator 400 may activate different AI agents and/or may configure the AI agents to adjust the tasks they perform for different dynamically defined actions. In this manner, AI agent orchestrator 400 scales compute complexity of the individual AI agents by adapting the AI agents and the different siloed tasks performed by each AI agents for the execution of larger objectives or workflows. The computational complexity scales without increasing compute resources of the AI agents by virtue of repurposing and reusing the existing AI agents in an on-demand or as-needed basis to effectuate the more computational complex objectives or workflows that the individual tasks of the AI agents were not trained for.

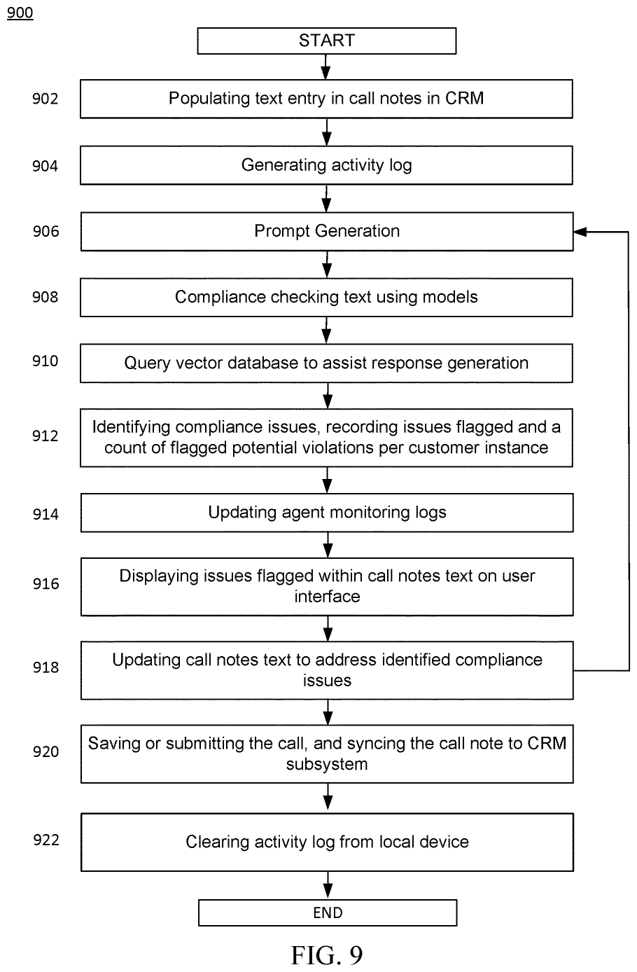

FIG. 9 presents a process 900 for dynamic unstructured text alignment monitoring in a customer relationship management system in accordance with some example embodiments. Process 900 is implemented by AI agent orchestrator 400 and CRM server 106. Process 900 begins at START and proceeds through a series of compliance checking, issue identification, and resolution steps designed to ensure that call notes entered by sales representatives comply with regulatory requirements in the life sciences industry.

Process 900 includes populating a text entry in call notes within the CRM application (at step 902). For example, CRM server 106 may populate the text entry in call notes. The text entry may comprise a free-text, or unstructured, description of an interaction with a healthcare professional (HCP), including details about topics discussed, questions raised by the HCP, product information shared, and any follow-up actions agreed upon. Unlike traditional structured input methods that rely on picklists and standardized templates, the free-text entry allows the user to capture the full context and nuances of the HCP interaction. The text entry may be authored directly by the user typing on a local device, or may be populated from a transcript generated by a voice agent that converted an audio recording of the user's dictation into text.

Process 900 includes generating (at step 904) an activity log to track the compliance checking process. For example, CRM server 106 may generate the activity log. The activity log may record timestamps indicating when the compliance check was initiated, user identifiers associating the check with a specific sales representative, and system state information capturing the context in which the check is being performed. The activity log provides an audit trail that enables compliance teams to monitor agent activity and review the history of compliance checks performed across the organization. In some implementations, the activity log may be stored temporarily on the local device during the compliance checking process and may be transmitted to a cloud infrastructure for long-term retention and analysis.

Process 900 includes generating (at step 906) prompt to prepare the text entry for compliance analysis. For example, AI agent orchestrator 400 (e.g., orchestrator 170) may receive the call notes text and call to models 160 (e.g., the LLM). The prompt generation may comprise conditioning a compliance model with prompt context including regulatory rules, approved reference language, and product-specific standard operating documents retrieved from a controlled content repository. The prompt may be assembled from modular advisor prompt components that are dynamically selected and combined based on user context including user type, country, and object type to apply correct compliance frameworks and regulatory requirements for the specific jurisdiction. The prompt may include instructions for the compliance model to explain its assessment rationale and provide a confidence interval with a score indicating the certainty of its findings. In some implementations, the prompt may include customer-provided compliance documents that define customer-specific areas of concern in addition to baseline compliance rules.

Process 900 includes executing (at step 908) compliance checking of the text using models 160. The compliance checking may comprise analyzing the text entry using a large language model (LLM) to identify non-compliant content across multiple compliance issue categories. The compliance issue categories may include inappropriate content screening to identify restricted words, profanity, and inappropriate content using the LLM's background training and understanding of professional language in the life sciences industry. The compliance issue categories may further include data protection screening to identify entry of protected health information (PHI) or personally identifiable information (PII) in unencrypted fields, with localized prompt sets provided for major markets tailored to meet specific regulatory requirements of each jurisdiction. The compliance issue categories may further include promotional compliance screening to identify off-label product promotion based on known regulations in major jurisdictions, wherein claims are checked for consistency with date-versioned prescribing information. The compliance issue categories may further include product restriction screening to identify mentions of products that are restricted or not allowed for selected accounts, locations, or attendee accounts. The compliance issue categories may further include safety vigilance screening to detect adverse events, serious adverse events, or product quality complaints outside of designated safety systems.

Process 900 includes querying (at step 910) a vector database to assist response generation. For example, models 160 (e.g., LLM) may query vector database to assist response generation. The vector database query may comprise executing a retrieval-augmented-generation (RAG) flow against a controlled content repository to obtain reference passages related to identified compliance concerns. The vector database 184 may store high-dimensional numerical vectors capturing semantic meaning of approved content that has passed medical, legal, and regulatory (MLR) review. The RAG flow may perform semantic search through the controlled content repository to identify supporting documentation related to the text entry, enabling the compliance model to compare the user's text against approved reference language and identify divergences. The vector database may be automatically updated whenever reference documents such as prescribing information documents and compliance documents are incrementally created, updated, or deleted, ensuring that the compliance analysis is performed against current approved content.

Process 900 includes identifying (at step 912) compliance issues, recording issues flagged and a count of flagged potential violations per customer instance. For example, models 160 (e.g., LLM) may return the text with identified alignment issues. The identified issues may include specific phrases or segments of the call notes text that were determined to be potentially noncompliant based on the compliance model's analysis. For each identified issue, the system may record the issue category, the specific text segment flagged, the rationale for flagging the segment, and a confidence score indicating the certainty of the compliance concern. The count of flagged potential violations may be aggregated at the customer instance level to enable compliance teams to monitor overall compliance trends and identify patterns of non-compliance across the organization. In some implementations, the system may distinguish between different severity levels of compliance issues, such as critical issues that must be resolved before saving and advisory issues that may be acknowledged but not necessarily corrected.

Process 900 includes updating (at step 914) agent monitoring logs. For example, AI agent orchestrator 400 (e.g., orchestrator 170) may update the agent monitoring logs. The agent monitoring logs may comprise an immutable audit record linking the original text entry, the identified compliance issues, the compliance model's rationale and confidence scores, and timestamps for each stage of the compliance checking process. The monitoring logs may be stored at a cloud infrastructure and retained according to a retention schedule, enabling compliance teams to access logs of the agent's findings via a data lakehouse for back-end monitoring and auditing. Each iteration of the compliance checking process, including re-checks triggered by user edits, may be logged separately to provide a complete history of the compliance review process. The monitoring logs may support regulatory reporting requirements and enable organizations to demonstrate due diligence in their compliance monitoring practices.

Process 900 includes displaying (at step 916) issues flagged within the call notes text on a user interface. For example, CRM server 106 may display visually highlighted divergent segments using color-coded highlighting to distinguish between different types of compliance issues. In some implementations, safety vigilance issues such as adverse events and product quality complaints may be highlighted in purple, while other compliance issues such as off-label messaging and PHI/PII may be highlighted in red. The user interface may present each flagged issue with an explanation of why the text was flagged, a reference to the applicable compliance rule or regulation, and one or more suggested actions for resolving the issue. The suggested actions may include one-click options to remove the highlighted text, replace the highlighted text with compliant alternative language, or acknowledge the issue without making changes. The user interface may also provide links to supporting documentation from the controlled content repository to enable the user to verify the compliance concern and understand the basis for the flagging.

Process 900 includes updating (at step 918) the call notes text to address the identified compliance issues. For example, CRM server 106 may accept proposed compliant replacement text suggested by the compliance model, edit the text to rephrase or remove non-compliant content, or remove the flagged text segments entirely. In some implementations, the method may return to step 906 to re-check the updated text for compliance after making edits, creating an iterative loop that continues until all compliance issues are resolved or acknowledged. Each iteration of the compliance checking process may be logged to the agent monitoring logs, providing a complete audit trail of the user's edits and the system's responses. In some implementations, identified compliance concerns must be cleared before the call note can proceed to save or submission, ensuring that non-compliant content is not persisted to the CRM system. If the call notes is exited without saving, the call note text may be deleted from the local device to prevent retention of potentially non-compliant content.

Process 900 includes saving or submitting (at step 920) the call, and syncing the call note to the CRM subsystem 104. The saving or submitting action may trigger a final compliance verification to ensure that all previously identified issues have been resolved. In some implementations, the system may be configured to block save or submit actions until all compliance issues are resolved, or may be configured to allow save or submit with unresolved issues while logging the user's acknowledgment of the outstanding concerns. Upon successful save or submit, the final call notes and any data extracted and saved to applicable structured fields are synced to a customer vault CRM instance, with retention being controlled by the customer according to their data retention policies.

Process 900 includes clearing (at step 922) the activity log from the local device. For example, CRM server 106 may automatically delete temporary data associated with the compliance checking process from the local storage of the mobile device for data protection purposes. The deletion may occur without displaying a confirmation prompt to the user, ensuring that sensitive data including the original text entry, intermediate compliance check results, and any audio or transcript data associated with voice-generated call notes is not retained on the local device after the call record has been successfully synced to the CRM subsystem. This automatic deletion supports compliance with data protection regulations and minimizes the risk of unauthorized access to sensitive healthcare interaction data.

In another implementation, the unstructured text alignment monitoring may be applied to electronic messages, such as approved emails, in real-time to dynamically check compliance, identify and resolve issues. The compliance monitoring system may extend beyond call notes to analyze free-text content within approved email templates prior to transmission to healthcare professionals (HCPs). When a user composes or customizes an approved email within the CRM application, the Text Monitoring Agent may intercept the email content and perform the same multi-category compliance analysis applied to call notes, including inappropriate content screening, data protection screening for PHI and PII, promotional compliance screening for off-label messaging, product restriction screening, and safety vigilance screening for adverse events and product quality complaints.

In some implementations, the compliance checking of electronic messages may be performed in-edit, such that the compliance check is automatically initiated when the user removes focus from an editable text field within the email template. The Text Monitoring Agent may generate dedicated advisor prompts for approved email compliance checking that are tailored to the specific regulatory requirements applicable to electronic communications with HCPs. The advisor prompts for approved email may differ from those used for call notes to account for the distinct regulatory frameworks governing promotional and non-promotional electronic communications in the life sciences industry.

In some aspects, the compliance monitoring of electronic messages may account for recipient-specific regulatory requirements. The compliance model may evaluate the jurisdiction where the recipient HCP is located and apply localized prompt sets tailored to meet the specific regulatory requirements of that jurisdiction. For example, an electronic message intended for an HCP in a jurisdiction with stricter advertising regulations may be subject to additional compliance checks that are not applied to messages intended for HCPs in other jurisdictions. The compliance model may cross-reference product claims in the electronic message against date-versioned prescribing information loaded into the controlled content repository using a retrieval-augmented-generation (RAG) flow to verify that all product claims are consistent with approved indications.

In some implementations, the CRM application may block editing of email content fields when the Text Monitoring Agent is offline or disabled, preventing users from composing or modifying electronic messages without the benefit of real-time compliance monitoring. The blocking may ensure that electronic messages are not transmitted without having undergone compliance analysis. When the Text Monitoring Agent is restored to an online state, the user may resume editing and the compliance checking process may be automatically re-initiated.

The compliance monitoring of electronic messages may generate monitoring logs that record all issues flagged, the LLM's rationale and confidence scores, and a count of flagged potential violations per customer instance. The monitoring logs may be stored at a cloud infrastructure and made accessible to compliance teams via a data lakehouse for back-end monitoring and auditing. Each compliance check iteration, including re-checks triggered by user edits to the email content, may be logged separately to provide a complete history of the compliance review process for the electronic message.

Upon successful compliance verification, the electronic message may be transmitted through the selected delivery channel, and the system may write an immutable audit record to the controlled content repository linking the full content of the communication as sent, the selected delivery channel, the recipient's profile and regulatory preference data, a transmission timestamp, the sender's user identifier, and a cryptographic hash of the communication material for integrity verification. The audit record may further include any modifications made to the content for compliance or personalization, as well as the delivery status of the electronic message.

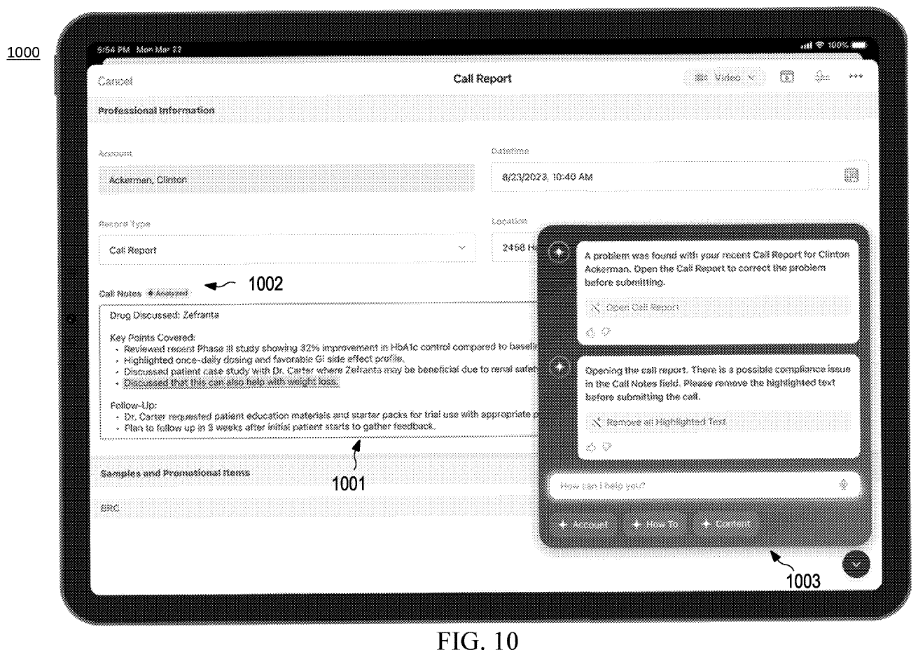

FIG. 10 illustrates an exemplary user interface 1000 screenshot depicting a call report with a compliance issue detected by the text alignment monitoring agent in accordance with some example embodiments. The user interface is displayed on a tablet device running a CRM application. The call report is associated with an account identified as “Ackerman, Clinton” and has a record type of “Call Report.” The call report includes structured fields including a Datetime field populated with “Aug. 23,2023, 10:40 AM” and a Location field populated with “2458 Hacienda Dr.”

The Call Notes field 1001 displays a compliance status indicator 1002 labeled “Analyzed” shown in a colored tag adjacent to the field label, indicating that the text alignment monitoring agent has completed its compliance analysis of the call notes content. The call notes contain a narrative description of an interaction with a healthcare professional, including a section labeled “Drug Discussed: Zefranta” followed by key points covered during the interaction. The key points include reviewing a recent Phase III study showing 32% improvement in HbA1c control compared to baseline, highlighting once-daily dosing and favorable GI side effect profile, discussing a patient case study with Dr. Carter where Zefranta may be beneficial due to renal safety, and discussing that the drug can also help with weight loss. The call notes further include a follow-up section noting that Dr. Carter requested patient education materials and starter packs for trial use with appropriate patients, and a plan to follow up in 3 weeks after initial patient starts to gather feedback. Certain text within the call notes is visually highlighted to indicate that the Text Monitoring Agent has identified potential compliance concerns within those segments.

A conversational interface panel 1003 is displayed on the right side of the screen, presenting a series of messages from the compliance monitoring system. A first message states “A problem was found with your recent Call Report for Clinton Ackerman. Open the Call Report to correct the problem before submitting.” An actionable link labeled “Open Call Report” is provided below this message. A second message states “Opening the call report. There is a possible compliance issue in the Call Notes field. Please remove the highlighted text before submitting the call.” An actionable link labeled “Remove all Highlighted Text” is provided, enabling the user to remove all flagged text segments with a single click. The conversational interface further includes navigation options for “How To,” “Content,” and “Account” to assist the user with additional information. This user interface demonstrates the system's ability to detect alignment issues in call notes and present remedial actions to the user through an integrated conversational interface.

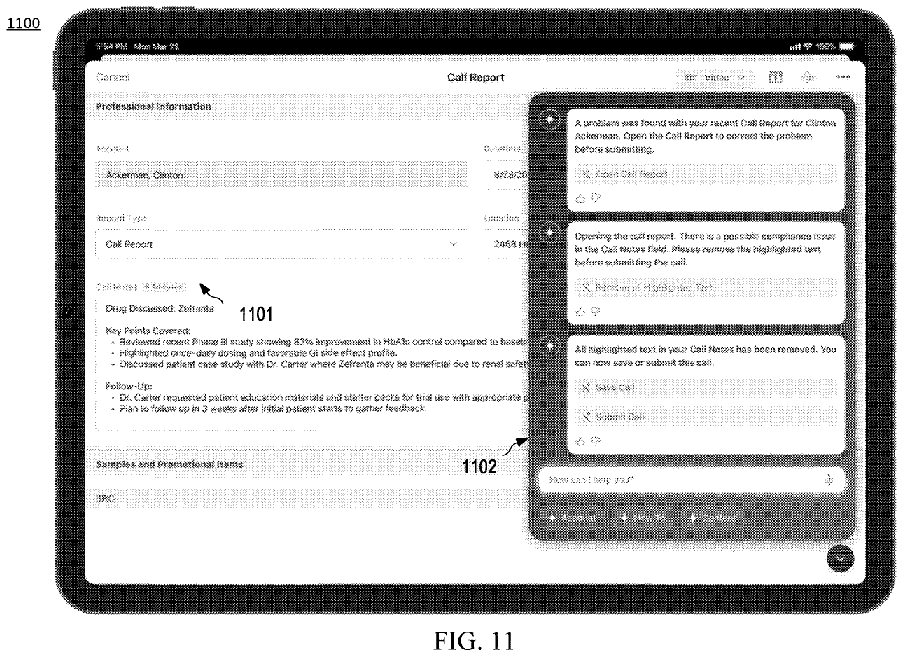

FIG. 11 illustrates an exemplary user interface 1100 screenshot depicting the call report after the user has accepted the remedial action to remove all highlighted text in accordance with some example embodiments. The user interface continues to display the same call report for “Ackerman, Clinton” with the same structured fields as shown in FIG. 10. The Call Notes field continues to display the “Analyzed” compliance status indicator 1101.

The call notes content has been updated to reflect the removal of the previously highlighted non-compliant text segments. The remaining call notes text includes the key points covered during the interaction, with the previously flagged content having been removed. The call notes now contain only compliant content that has passed the Text Monitoring Agent's compliance analysis.

The conversational interface panel 1102 on the right side of the screen displays an updated series of messages reflecting the progression of the compliance remediation workflow. The first two messages from FIG. 10 remain visible, followed by a new message stating “All highlighted text in your Call Notes has been removed. You can now save or submit this call.” Below this confirmation message, two actionable links are presented: “Save Call” and “Submit Call,” enabling the user to proceed with saving or submitting the now-compliant call report. This user interface demonstrates the system's ability to remove flagged text with a single click and to confirm to the user that the compliance issues have been resolved, enabling the user to proceed with saving or submitting the call.

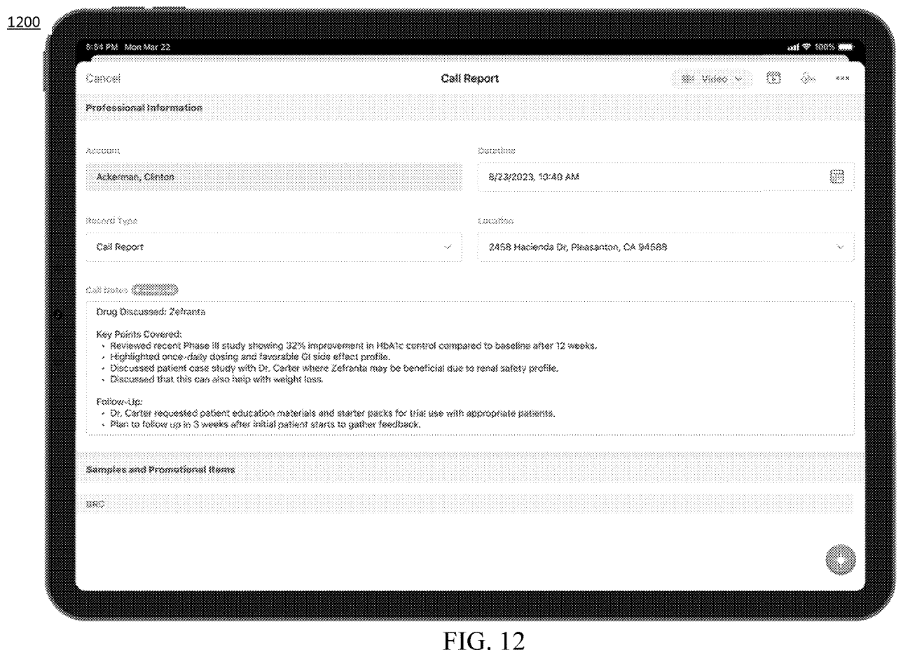

FIG. 12 illustrates an exemplary user interface 1200 screenshot depicting a compliant call report that has been verified by the Text Monitoring Agent without any compliance issues detected in accordance with some example embodiments. The user interface displays the same call report for “Ackerman, Clinton” with the Datetime field populated with “Aug. 23,2023, 10:40 AM” and the Location field populated with “2458 Hacienda Dr, Pleasanton, CA 94588.”

The Call Notes field displays a compliance status indicator labeled “Analyzed” shown in a green-colored tag, indicating that the Text Monitoring Agent has completed its compliance analysis and has verified the call notes content as compliant. The call notes contain a narrative description of the interaction including the drug discussed (Zefranta), key points covered including reviewing a recent Phase III study showing 32% improvement in HbA1c control compared to baseline after 12 weeks, highlighting once-daily dosing and favorable GI side effect profile, discussing a patient case study with Dr. Carter where Zefranta may be beneficial due to renal safety profile, and discussing that the drug can also help with weight loss. The follow-up section notes that Dr. Carter requested patient education materials and starter packs for trial use with appropriate patients, and a plan to follow up in 3 weeks after initial patient starts to gather feedback. No text is highlighted within the call notes, indicating that no compliance issues were detected. An orange star icon is displayed in the upper right area of the screen, which may indicate a verified or compliant status. This user interface demonstrates the system's presentation of a call report that has passed all compliance checks without any flagged issues.

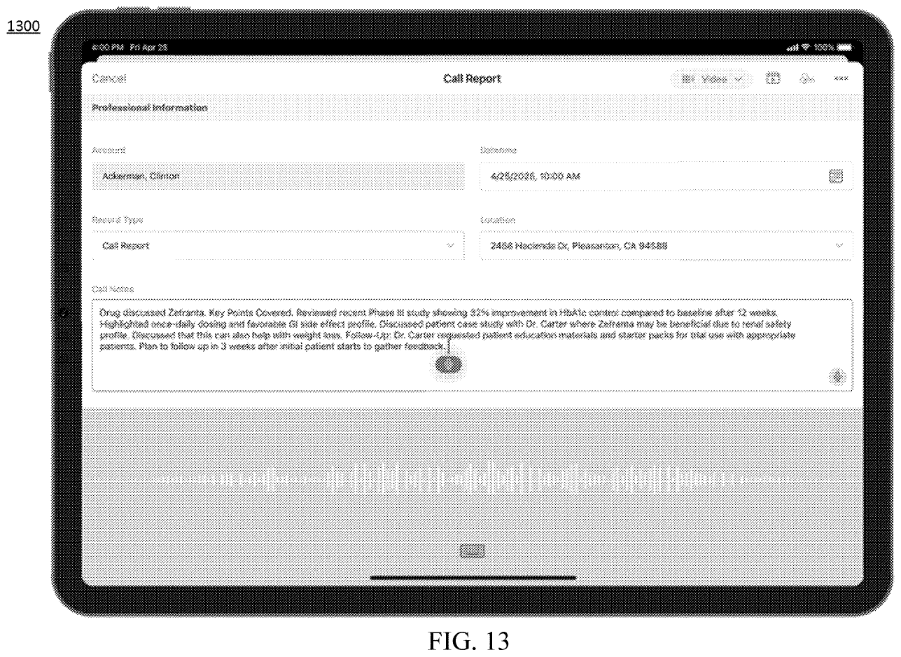

FIG. 13 illustrates an exemplary user interface 1300 screenshot depicting a call report with call notes that have been populated from a voice note transcription in accordance with some example embodiments. In one implementation, the voice note transcription may be implemented with a voice agent. The user interface is displayed on a tablet device running the CRM application. The call report is associated with the account “Ackerman, Clinton” with a Record Type of “Call Report,” a Datetime field populated with “Apr. 25,2025, 10:00 AM,” and a Location field populated with “2458 Hacienda Dr, Pleasanton, CA 94588.”

The Call Notes field contains a continuous narrative text that reads: “Drug discussed Zefranta. Key Points Covered. Reviewed recent Phase III study showing 32% improvement in HbA1c control compared to baseline after 12 weeks. Highlighted once-daily dosing and favorable GI side effect profile. Discussed patient case study with Dr. Carter where Zefranta may be beneficial due to renal safety profile. Discussed that this can also help with weight loss. Follow-Up: Dr. Carter requested patient education materials and starter packs for trial use with appropriate patients. Plan to follow up in 3 weeks after initial patient starts to gather feedback.” The narrative format of the call notes, presented as a continuous paragraph rather than structured bullet points, indicates that the text was generated from a voice note transcription where the user dictated the details of the interaction. A blue circular icon is displayed at the end of the text entry, and an audio waveform visualization is displayed to the right of the call notes field, indicating that the voice recording is associated with the call notes and that the transcription was generated from the audio input. This user interface demonstrates the voice agent's ability to convert a dictated voice note into a populated call notes field within the call report.

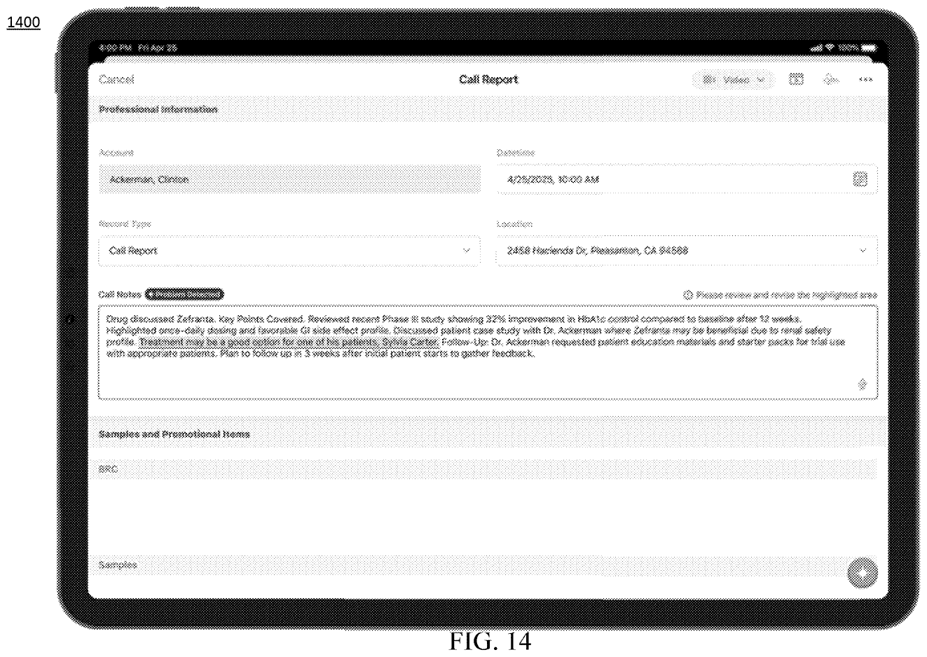

FIG. 14 illustrates an exemplary user interface screenshot depicting a call report with call notes populated from a voice note transcription that has been analyzed by the Text Monitoring Agent and found to contain compliance issues in accordance with some example embodiments. The user interface displays the same call report for “Ackerman, Clinton” with the same structured fields as shown in FIG. 13.

The Call Notes field displays a compliance status indicator labeled “Problem Detected” shown in a red-colored tag, indicating that the Text Monitoring Agent has completed its compliance analysis and has identified one or more compliance concerns within the call notes content. A red warning message is displayed above the call notes text stating “Please review and revise the highlighted area.” The call notes contain the same narrative text as FIG. 13, but with certain text segments visually highlighted in red to indicate the specific portions of the text that the Text Monitoring Agent has identified as potentially non-compliant. The highlighted segments appear to include references to specific patient case studies and product claims that may constitute off-label messaging or other compliance violations. The call notes field is bordered with a red outline to further emphasize that compliance issues have been detected and require the user's attention before the call report can be saved or submitted. An orange star icon is displayed in the upper right area of the screen. Below the call notes, the user interface displays sections for “Samples and Promotional Items,” “BRC,” and “Samples,” indicating additional structured data fields within the call report. This user interface demonstrates the integration of the voice agent and the Text Monitoring Agent, wherein call notes generated from a voice note transcription are automatically subjected to compliance analysis, and any detected issues are visually highlighted for the user to review and resolve before submitting the call report.

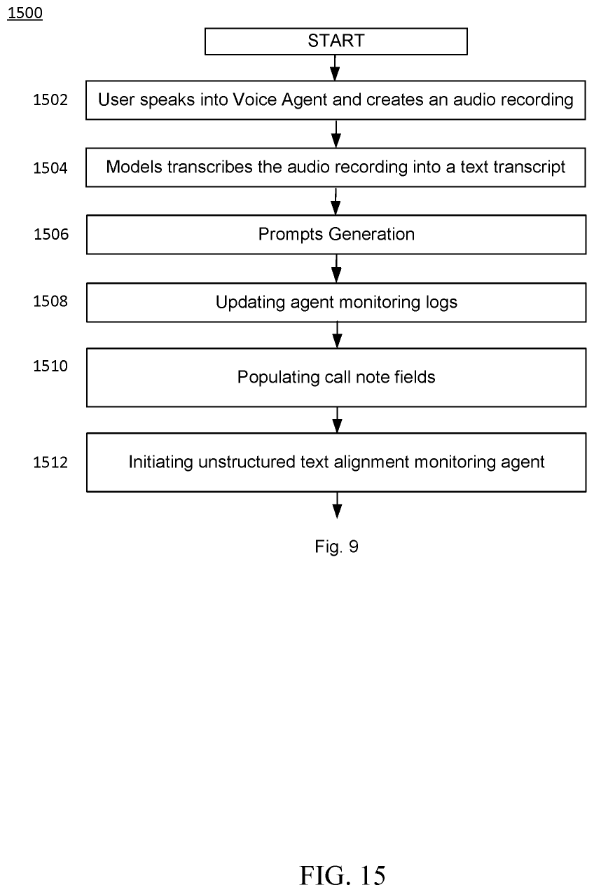

FIG. 15 illustrates a flowchart of a method 1500 for generating a call record from a voice note and initiating alignment monitoring in accordance with some example embodiments. The method 1500 depicts the end-to-end workflow from voice capture through call record population and handoff to the unstructured text alignment monitoring agent.

Process 1500 includes creating (at step 1502) an audio recording. For example, a user may speak into the voice agent. The user may be a sales representative who has recently completed an interaction with a healthcare professional (HCP) and wishes to capture the details of the interaction while the interaction is still recent in memory. The user may record the voice note using a voice recording interface of a customer relationship management (CRM) application on a mobile device, such as a tablet or smartphone. In some implementations, the user may record the voice note while driving back from the interaction, enabling hands-free documentation of the interaction details. The audio recording may be stored temporarily on the local device and may not be transmitted to a remote server. The voice agent may support custom pronunciation dictionaries through a voice dictionary object that maps spoken pronunciations to corresponding terms stored in the CRM database, enabling accurate transcription of industry-specific terminology, product names, and healthcare professional names. The voice agent may also support pause and resume functionality during the voice recording, allowing the user to pause the recording and resume at a later time without losing the previously recorded audio.

Process 1500 includes transcribing (at step 1504) the audio recording into a text transcript. For example, models 160 may be utilized to transcribe the audio. A speech transcription engine, which may execute locally on the mobile device, converts the audio recording into text in real time. The transcription may begin immediately upon the user initiating the voice recording without requiring manual user intervention. The speech transcription engine may apply the custom pronunciation dictionary to improve the accuracy of the transcription for domain-specific terms. The text transcript may be stored temporarily on the local device alongside the audio recording. In some implementations, the transcript is generated using an on-device speech recognition framework, such as iOS SpeechTranscriber, to ensure that the audio data remains on the local device and is not transmitted to external servers for transcription. The voice agent may allow users to pause and resume call voice note recording during dictation. A pause button may display on the call voice note page. When the user taps the pause button, the audio recording and transcript generation may pause. A visual indicator may display to show that the recording is paused, along with a resume button. When the user taps the resume button, the audio recording and transcript generation may resume. The pause and resume functionality may allow users to temporarily stop recording and continue recording at a later time without losing the previously recorded audio and transcript.

Process 1500 includes performing (at step 1506) prompt generation. For example, AI agent orchestrator 400 may assemble a structured prompt that includes the text transcript along with contextual information required for the artificial intelligence (AI) orchestration layer to extract structured data from the unstructured transcript. The prompt may include instructions for the Voice agent to identify specific call record fields from the transcript, such as the account associated with the interaction, the datetime of the interaction, the communication channel, products discussed, follow-up tasks, and remaining narrative information for the call notes field. The prompt may further include reference data required for field extraction, such as account records with name fields, formatted name fields, and phonetic name fields for account identification, product records associated with the user for product identification, and user records for follow-up task assignee identification. The prompt may be transmitted to the Voice agent, which may be hosted on a cloud infrastructure, for processing by a large language model (LLM).

Process 1500 includes updating (at step 1508) agent monitoring logs. For example, AI agent orchestrator 400 may record various details in the agent monitoring logs, including: the prompt sent to the LLM, the LLM response, and metadata associated with the voice-to-call-record conversion process. The monitoring logs may include the structured response from the LLM comprising the expected output for each extracted field, such as ID fields for account identification, API names for picklist values, and strings for text fields, along with the information to populate the applicable CRM fields. The monitoring logs may be stored at a cloud infrastructure and retained according to a retention schedule, enabling compliance teams to access logs of the agent's activities for back-end monitoring and auditing. The LLM itself may store no substantive data from prompts or responses.

Process 1500 includes populating (at step 1510) call note fields. A field mapping module may map the structured response returned from the LLM to respective call note fields in CRM. The Voice agent returns a structured response comprising the extracted call record fields, and the voice agent automatically populates a call record with the extracted data. The populated fields may include an account identifier determined by matching name references in the transcript against account records stored in the CRM database, a datetime of the interaction, a communication channel, one or more products discussed with numeric rank based on mention order, and one or more follow-up tasks including assignee, due date, and task description. Remaining information from the transcript that was not assigned to a specific structured field may be formatted with rich text using bullet points and populated into the call notes field. The AI source field may be automatically set to indicate that the call was created through the voice agent, regardless of user permissions or page layout placement. The populated call record may be presented to the user via a user interface of the CRM application for validation, enabling the user to review and edit the extracted data before saving or submitting the call record. When the account identification returns multiple candidate accounts, the user interface may display an account selector listing the candidate accounts for user selection, with suggested accounts displayed above all accounts.

In some aspects, the Voice agent may automatically extract a plurality of call record fields from the transcript by comparing linguistic tokens in the transcript to a field layout of a call object in the customer relationship management system. The extraction process may be layout-driven, such that the specific fields extracted from the transcript are determined by the page layout configuration associated with the call object type in the CRM system.

When there is no account context established prior to the voice note dictation, the transcript may be sent to the Voice agent in a first request that initially asks only for the account identification. The voice agent may analyze the transcript to determine who the meeting or conversation was with by matching content from the transcript against account records stored in the CRM database. The voice agent may consider a name field, a last name field, a first name field, a formatted name field, and a furigana field of the account records when determining which account records match the content from the transcript. The voice agent may return one or more matching account identifiers based on the matching process.

When the account identifier is returned, a client layer may identify the layout associated with the default call object type for the identified account. The layout information, comprising fields, controls, and sections defined on the page layout, may determine which requests are made to the Voice agent for a second request. In this manner, the system may dynamically adapt the field extraction process based on the specific page layout configuration, such that different call object types with different page layouts may result in different sets of fields being extracted from the same transcript. Only fields that are present on the page layout may be extracted from the transcript, ensuring that the extraction process is aligned with the CRM configuration and that the Voice agent does not attempt to populate fields that are not applicable to the specific call object type.

When there is an account context already established prior to the voice note dictation, the first request for account identification may be skipped, and the client layer may directly identify the layout associated with the default call object type for the established account context. The layout information may then determine which requests are made to the Voice agent for field extraction from the transcript.

Voice agent may extract a plurality of call record fields from the transcript based on the layout information. The extracted fields may include a datetime of the interaction, which may be automatically set on the created call record. The extracted fields may further include a communication channel identifier for setting the communication channel on the call record. The extracted fields may further include one or more products discussed during the interaction, which may be identified by analyzing product records associated with the user and returning product identifiers with a numeric rank based on mention order in the transcript. The extracted fields may further include one or more follow-up tasks, which may be identified by extracting assignee user identifiers, due dates, and task text from the transcript for automatic creation of call follow-up task records. An AI source field may be automatically set to indicate that the call was created through the voice agent, regardless of user permissions or page layout placement.

Remaining information from the transcript that was not documented in another call field or call section may be identified by voice agent. Voice agent may determine if there was any information included in the voice note that was not used to populate a specific structured field. The remaining information may be structured in sentence format from the perspective of the user, using bullet points when appropriate to structure the information. The remaining information may be set as the call notes field on the call record, provided that the call notes field is present on the layout of the call and the user has edit permission to the call notes field.

In some implementations, certain actions may be limited to conserve token usage. For instance, voice control for medical insight may be limited in some embodiments. Using AI to extract date, account plan, clinical trial, interaction, medical event, other source, publication, or summary fields for the medical insight may be dictated as the user wants it written rather than being extracted by the Voice agent.

Voice agent may identify accounts from call voice notes. Voice agent may analyze a transcript generated from a call voice note to determine who a meeting or conversation was with. Voice agent may match content from the transcript against account records stored in a customer relationship management (CRM) database. In some aspects, voice agent may consider a name field, a last name field, a first name field, a formatted name field, and a furigana field of the account records when determining which account records match the content from the transcript. Voice agent may return one or more matching account identifiers based on the matching process. In some cases, if there are no matches between the transcript content and the account records, the voice agent may not provide any account identifiers.

When a single account is identified from a call voice note, the voice agent may automatically create a call record for that account. In some aspects, the automatic call record creation may not apply when an account context was already established prior to the voice note dictation.

When multiple accounts are identified from a call voice note, the voice agent may display an account selector user interface for user selection. The account selector user interface may include a suggested accounts section and an all accounts section. The suggested accounts section may display the matching accounts returned by the AI orchestration layer. The suggested accounts section may appear above the all accounts section in the account selector user interface. The all accounts section may display additional accounts available for selection. The user may select an account from either the suggested accounts section or the all accounts section. In some cases, the account selector user interface may include a search function that allows the user to search the CRM database for additional accounts.

In some aspects, when the AI orchestration layer identifies multiple accounts, an information banner may display in the account selector user interface. The information banner may indicate the account name string identified from the transcript by the AI orchestration layer. When multiple account name strings are identified, the information banner may list the strings in a comma-separated format.

When no accounts are identified from a call voice note, the voice agent may display the account selector user interface for manual account selection. In some cases, an information banner may indicate that the Voice agent could not identify any account from the transcript. In other cases, when an account name string was identified from the transcript but no matching account records were found, the information banner may indicate the identified account name string and notify the user that no matching records exist.

Upon selection of an account from the account selector user interface, the voice agent may create a call record for the selected account. The call record may be created with a default object type based on the account type. Default values for territory, address, location, and pre-call notes may be populated on the call record.

Process includes initiating (at step 1512) the unstructured text alignment monitoring agent. For example, AI agent orchestrator 400 may call the unstructured text alignment monitoring agent. Upon the call notes field being populated by the voice agent, the text monitoring agent may be automatically activated to perform compliance checking on the populated call notes content. The handoff from the voice agent to the text monitoring agent may occur when the voice agent creates a call record and the call notes field is not null or blank. In some implementations, when the system is configured for in-edit compliance checking, the compliance check may start immediately upon the call notes field being populated. The text monitoring agent may operate as an autonomous, headless agent that does not use the agent chat user interface. The compliance checking performed by the text monitoring agent is not performed by the voice agent itself but is instead performed by the dedicated text monitoring agent as a separate compliance process. The method 1500 then proceeds to the compliance checking workflow illustrated in FIG. 9, where the text monitoring agent performs the multi-category compliance analysis including inappropriate content screening, data protection screening, promotional compliance screening, product restriction screening, and safety vigilance screening on the voice-generated call notes content.

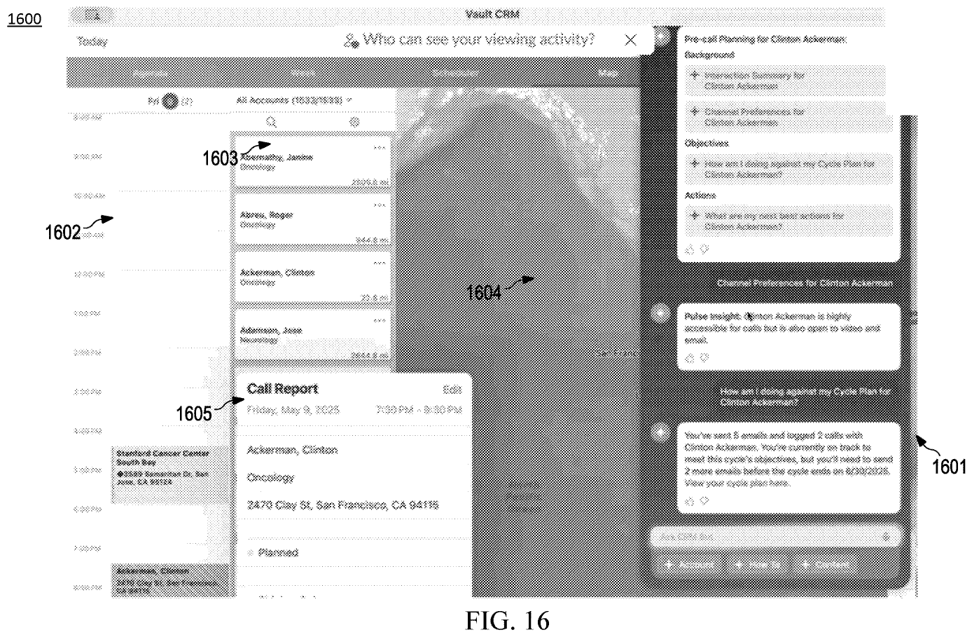

FIG. 16 illustrates a user interface 1600 of a CRM application displaying a scheduler view with an integrated AI assistant chat panel 1601 providing pre-call planning assistance. The left portion of the screen shows a weekly scheduler interface with tabs for “Agenda,” “Week,” and “Map” views. A vertical timeline 1602 displays time slots from 8:00 AM through 8:00 PM, with a list of healthcare professional accounts 1603 including Abernathy, Janine (Oncology) at 2509.6 mi, Abreu, Roger (Oncology) at 944.8 mi, Ackerman, Clinton (Oncology) at 22.8 mi, and Adamson, Jose (Neurology) at 2644.8 mi. The map view 1604 on the right side of the scheduler shows the San Francisco Bay Area with the North Pacific Ocean visible.

A Call Report detail card 1605 is overlaid on the scheduler, displaying information for a planned call with Ackerman, Clinton scheduled for Friday, May 9, 2025 from 7:30 PM-9:30 PM. The call location is listed as 2470 Clay St, San Francisco, CA 94115, with the specialty indicated as Oncology and the call status marked as “Planned.” An “Edit” button is available in the upper right corner of the card. Below the call details, the Stanford Cancer Center South Bay location card is visible showing the address as 2589 Samaritan Dr, San Jose, CA 95124.

The AI assistant chat panel 1601 on the right side of the screen displays a structured pre-call planning interface for Clinton Ackerman. The panel is organized into logical sections with expandable options: Under the “Background” section header, two expandable options are presented:
“Interaction Summary for Clinton Ackerman”—allowing the user to retrieve a summary of past interactions
“Channel Preferences for Clinton Ackerman”—providing insight into the customer's preferred communication channels

The “Channel Preferences for Clinton Ackerman” section is expanded, displaying a “Pulse Insight” that states: “Clinton Ackerman is highly accessible for calls but is also open to video and email.” This insight helps the sales representative understand the customer's communication preferences before the upcoming call.

Under the “Objectives” section header, an expandable option is presented:
“How am I doing against my Cycle Plan for Clinton Ackerman?”—allowing the user to check their progress against sales cycle objectives.

This option is expanded, and the AI assistant provides a detailed response: “You've sent 5 emails and logged 2 calls with Clinton Ackerman. You're currently on track to meet this cycle's objectives, but you'll need to send 2 more emails before the cycle ends on Jun. 30, 2025.” A link to “View your cycle plan here” is provided for additional details.

Under the “Actions” section header, an expandable option is presented:
“What are my next best actions for Clinton Ackerman?”—providing AI-generated recommendations for next steps

The chat panel includes navigation tabs at the bottom for “Account,” “How To,” and “Content” to allow the user to switch between different types of AI assistance. The “Ask CRM Bot” input field is visible at the bottom of the panel, enabling the user to type custom queries.

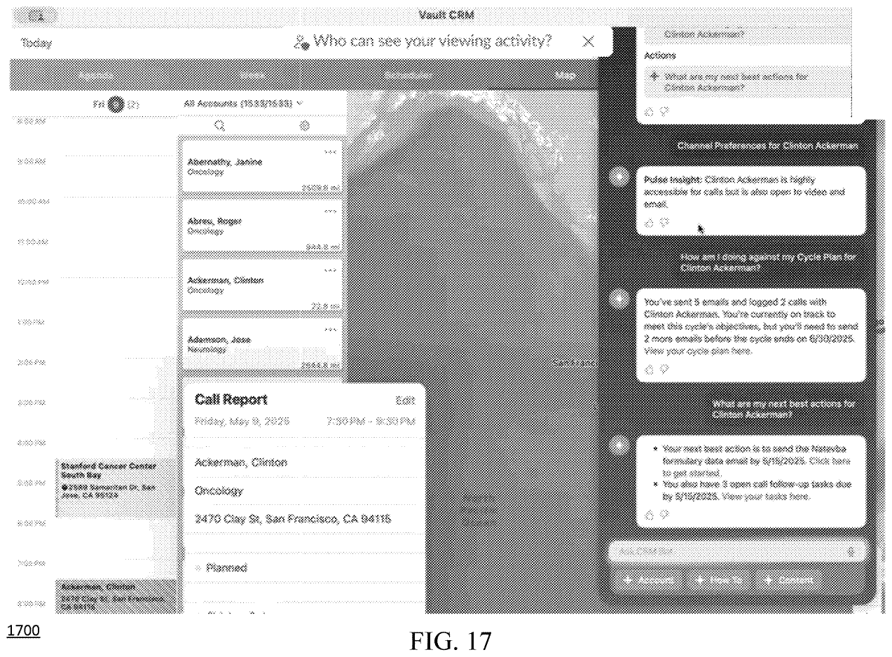

FIG. 17 illustrates the same CRM scheduler view 1700 with the AI assistant chat panel now displaying the response to the “What are my next best actions for Clinton Ackerman?” query. The scheduler interface remains consistent with FIG. 16, showing the weekly view with the list of healthcare professional accounts and their associated distances, the map view of the San Francisco Bay Area, and the Call Report detail card for the planned call with Ackerman, Clinton on Friday, May 9, 2025 from 7:30 PM-9:30 PM at 2470 Clay St, San Francisco, CA 94115.

The AI assistant chat panel on the right side displays the complete pre-call planning conversation thread. The “Channel Preferences for Clinton Ackerman” section shows the Pulse Insight indicating that Clinton Ackerman is highly accessible for calls but is also open to video and email.

The “How am I doing against my Cycle Plan for Clinton Ackerman?” section displays the previously shown response about sending 5 emails and logging 2 calls, being on track to meet objectives, and needing to send 2 more emails before the cycle ends on Jun. 30, 2025, with a link to view the cycle plan.

The “What are my next best actions for Clinton Ackerman?” section is now expanded with the AI assistant's response providing specific, actionable recommendations:

The response states: “Your next best action is to send the Natevba formulary data email by May 15, 2025. Click here to get started.” This provides a specific task with a deadline and a direct action link.

Additionally, AI agent orchestrator 400 notes: “You also have 3 open call follow-up tasks due by May 15, 2025. View your tasks here.” This alerts the user to pending tasks and provides a link to access the task list.

This interface demonstrates how the AI assistant synthesizes data from multiple CRM sources—including cycle plans, email logs, call records, and task management systems—to provide contextually relevant, prioritized action recommendations that help the sales representative prepare effectively for their upcoming customer interaction. The recommendations are time-sensitive and include direct links to execute the suggested actions, streamlining the pre-call planning workflow.

The chat panel maintains the navigation tabs at the bottom for “Account,” “How To,” and “Content,” along with the “Ask CRM Bot” input field for additional queries.

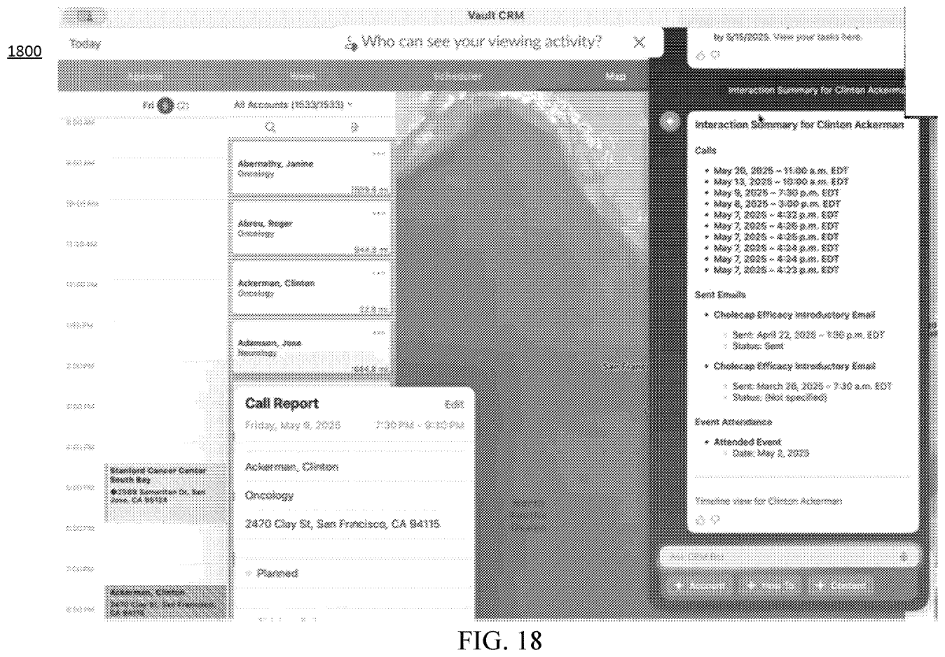

FIG. 18 illustrates the CRM scheduler view 1800 with the AI assistant chat panel displaying a comprehensive “Interaction Summary for Clinton Ackerman” dated May 15, 2025. The scheduler interface remains consistent with the previous figures, showing the weekly view with healthcare professional accounts listed (Abernathy, Janine; Abreu, Roger; Ackerman, Clinton; Adamson, Jose) with their specialties and distances, the map view of the San Francisco Bay Area, and the Call Report detail card for the planned call with Ackerman, Clinton.

The AI assistant chat panel provides a detailed chronological summary of all interactions with Clinton Ackerman, organized into distinct categories:

### Calls Section

The summary lists multiple call interactions with specific dates and times in Eastern Daylight Time (EDT):
May 20, 2025-11:00 a.m. EDT
May 13, 2025-10:00 a.m. EDT
May 9, 2025-3:30 p.m. EDT
May 9, 2025-3:00 p.m. EDT
May 7, 2025-4:32 p.m. EDT
May 7, 2025-4:26 p.m. EDT
May 7, 2025-4:25 p.m. EDT
May 7, 2025-4:24 p.m. EDT
May 7, 2025-4:24 p.m. EDT
May 7, 2025-4:23 p.m. EDT

This comprehensive call log provides the sales representative with visibility into the frequency and timing of recent interactions, enabling them to understand engagement patterns and avoid over-contacting or under-contacting the customer.

### Sent Emails Section

The summary displays email communications sent to Clinton Ackerman:
Cholecap Efficacy Introductory Email
Sent: Apr. 22, 2025-1:30 p.m. EDT
Status: Sent
Cholecap Efficacy Introductory Email
Sent: Mar. 26, 2025-7:30 a.m. EDT
Status: (Not specified)

This email history allows the representative to understand what content has already been shared with the customer, preventing redundant communications and enabling more informed follow-up conversations.

### Event Attendance Section

The summary includes event participation data:
Attended Event
Date: May 2, 2025

This indicates that Clinton Ackerman attended a company-sponsored event, which provides valuable context for the upcoming call—the representative can reference the event, discuss topics covered, or follow up on any questions that arose during the event.

At the bottom of the interaction summary, a link is provided: “Timeline view for Clinton Ackerman” which allows the user to access a more detailed, visual timeline representation of all interactions.

This interaction summary demonstrates the AI assistant's ability to aggregate data from multiple CRM subsystems-call logging, email tracking, and event management-into a unified, easily digestible format. By presenting this information in the context of pre-call planning, the system enables sales representatives to quickly review their interaction history and enter customer conversations fully informed about past touchpoints, topics discussed, and the overall relationship trajectory. This contextual awareness supports more personalized, effective customer engagement and helps maintain compliance with contact frequency guidelines.

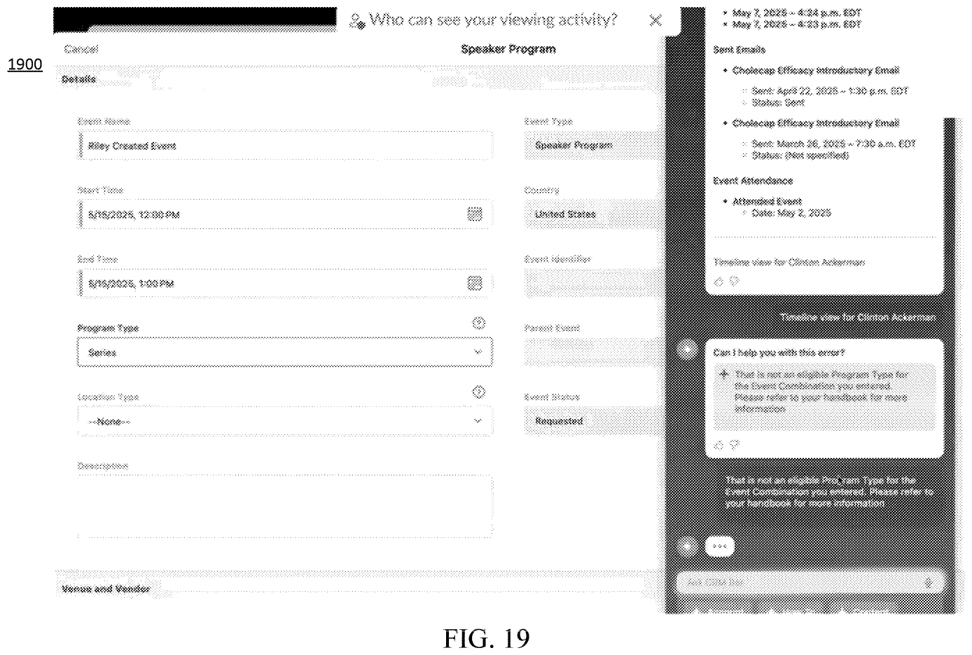

FIG. 19 illustrates a user interface 1900 of the Vault CRM application displaying a Speaker Program event creation form with an error state and an integrated AI assistant chat panel providing contextual error assistance. The left portion of the screen shows the event form with a “Cancel” button in the upper left corner. The form is organized into a “Details” section containing multiple input fields.

The event details fields include: Event Name (populated with “Riley Created Event”), Start Time (May 15, 2025, 12:00 PM), End Time (May 15, 2025, 1:00 PM), Program Type (highlighted in red with “Series” selected, indicating an invalid selection), Location Type (showing “—None—”), and Description (empty). Additional fields on the right side of the form include: Event Type (Speaker Program), Country (United States), Event Identifier (with a calendar icon), Parent Event (with a navigation arrow), and Event Status (Requested). The Program Type field is outlined in red, visually indicating that this field contains a validation error that must be corrected before the form can be saved.

Below the Details section, a “Venue and Vendor” section header is visible, indicating additional form fields for location and vendor information.

The AI assistant chat panel on the right side of the screen displays a conversation thread providing pre-call planning context and error assistance. The upper portion of the chat shows historical interaction data including:
Sent Emails: “Cholecap Efficacy Introductory Email” sent Apr. 22, 2025-1:30 p.m. EDT with Status: Sent, and “Cholecap Efficacy Introductory Email” sent Mar. 26, 2025-7:30 a.m. EDT with Status: (Not specified)
Event Attendance: “Attended Event” on Date: May 2, 2025
A link to “Timeline view for Clinton Ackerman”

Below the interaction history, the AI assistant proactively detects the form error and initiates assistance by asking: “Can I help you with this error?” The bot then provides an initial explanation: “That is not an eligible Program Type for the Event Combination you entered. Please refer to your handbook for more information.”

This interface demonstrates the AI assistant's ability to detect error conditions within the CRM client application based on the user's current workflow context and proactively offer assistance without requiring the user to explicitly request help. The system captures the context of the user's location within the application (e.g. the Speaker Program form in events management), identifies the validation error (invalid Program Type selection), and provides relevant guidance to help the user understand and resolve the issue.

The chat panel includes navigation tabs at the bottom for “Account,” “How To,” and “Content,” along with the “Ask CRM Bot” input field for additional queries. A menu icon (three dots) is visible, providing access to additional chat options.

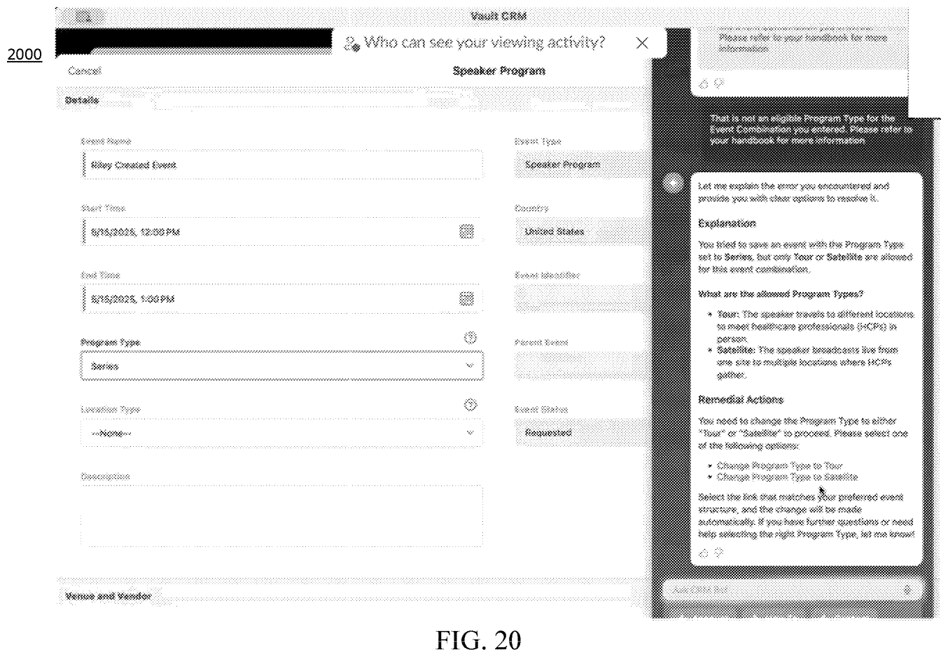

FIG. 20 illustrates the same events management Speaker Program event creation form 2000 with the AI assistant chat panel now displaying a comprehensive error explanation and actionable remedial options. The form interface remains consistent with FIG. 21, showing the event details with the Program Type field highlighted in red indicating the “Series” selection is invalid for this event type.

The AI assistant chat panel provides a detailed, structured response to help the user understand and resolve the error:

### Error Acknowledgment Section

The bot begins by acknowledging the error: “That is not an eligible Program Type for the Event Combination you entered. Please refer to your handbook for more information.” This mirrors the system error message while indicating the bot is aware of the issue.

### Explanation Section

Under the “Explanation” header, the bot provides context about why the error occurred: “Let me explain the error you encountered and provide you with clear options to resolve it.” The bot then states: “You tried to save an event with the Program Type set to Series, but only Tour or Satellite are allowed for this event combination.”

### Educational Content Section

Under the “What are the allowed Program Types?” header, the bot provides detailed definitions of the valid options:
Tour: “The speaker travels to different locations to meet healthcare professionals (HCPs) in person.” This option is appropriate when the speaker will physically visit multiple sites.
Satellite: “The speaker broadcasts live from one site to multiple locations where HCPs gather.” This option is appropriate for remote broadcast events where attendees join from various locations.

This educational content helps the user understand not just what options are available, but when each option is appropriate, enabling informed decision-making.

### Remedial Actions Section

Under the “Remedial Actions” header, the bot provides clear guidance: “You need to change the Program Type to either ‘Tour’ or ‘Satellite’ to proceed. Please select one of the following options:”

Two actionable buttons are presented:
“Change Program Type to Tour”—Selecting this option will automatically update the form field
“Change Program Type to Satellite”—Selecting this option will automatically update the form field

The bot adds helpful context: “Select the link that matches your preferred event structure, and the change will be made automatically. If you have further questions or need help selecting the right Program Type, let me know!”

This interface demonstrates several key capabilities of the AI-assisted workflow management system:
1. Context-Aware Error Detection: The system detects errors based on the user's current location and workflow stage within the CRM application.
2. Reference Documentation Integration: The bot references handbook documentation to explain the error and provide accurate guidance, ensuring responses are grounded in approved reference materials.
3. Actionable Remediation: Rather than simply explaining the error, the bot provides executable actions that can automatically correct the form field, streamlining the error resolution process.
4. Educational Assistance: The bot explains the underlying business rules (why only Tour or Satellite are valid for Speaker Programs), helping users learn the system requirements and avoid similar errors in the future.
5. Conversational Continuity: The chat panel maintains the conversation history, allowing users to see the progression from error detection to explanation to remediation options.

The chat panel includes navigation tabs at the bottom for “Account,” “How To,” and “Content,” along with the “Ask CRM Bot” input field, enabling the user to ask follow-up questions if additional clarification is needed.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments. It should be understood, that terms “user” and “participant” have equal meaning in the following description.

1. A system for AI-assisted enterprise management interface, comprising:
a customer relationship management (CRM) server configured to provide access to a CRM subsystem storing customer information;
a controlled content repository storing approved content;
a user computing device executing a CRM client application, the CRM client application including a user interface element providing access to a chat dialogue, wherein the user interface element is configured to capture context data based on a current location of a user within the CRM client application; and
an orchestrator configured to:
receive a prompt from the user interface element along with the context data;
transmit the prompt and the context data to a large language model (LLM) endpoint; and
process a response from the LLM endpoint and return a result to the user interface element.

2. The system of claim 1, wherein the orchestrator is further configured to transmit a list of available functions to the LLM endpoint, wherein the LLM endpoint selects one or more functions from the list of available functions based on the prompt.

3. The system of claim 2, wherein the orchestrator is further configured to:
receive a function call request from the LLM endpoint;
execute the function call request to obtain function results; and
transmit the function results to the LLM endpoint for summarization.

4. The system of claim 1, further comprising a vector database storing vectorized representations of content from the controlled content repository, wherein the orchestrator is configured to perform semantic search operations against the vector database based on the prompt.

5. The system of claim 4, wherein the content from the controlled content repository is chunked and transformed into the vectorized representations after approval through a medical and legal review process.

6. The system of claim 1, wherein the context data includes at least one of: an account identifier, a user identifier, a user type, a territory identifier, or a workflow stage.

7. The system of claim 1, wherein the user interface element is accessible from a plurality of different screens within the CRM client application.

8. The system of claim 1, further comprising a compliance model configured to detect non-compliant content in free text input, wherein the non-compliant content includes at least one of: protected health information (PHI), personally identifiable information (PII), or off-label messaging.

9. The system of claim 8, wherein the orchestrator is configured to provide a suggested remedial action responsive to detection of the non-compliant content.

10. The system of claim 1, wherein the LLM endpoint is provided by a customer and is accessible via an application programming interface (API).

11. The system of claim 10, further comprising CRM bot settings storing at least one of: an LLM access token, an LLM endpoint address, or a security profile-based configuration.

12. The system of claim 1, wherein the orchestrator is configured to provide content filters and guardrails to the LLM endpoint, wherein the content filters and guardrails define questions that the LLM endpoint is permitted to answer.

13. A method for AI-assisted workflow management, comprising:
displaying, by a user computing device, a user interface element within a customer relationship management (CRM) client application, the user interface element providing access to a chat dialogue;
capturing, by the user interface element, context data based on a current location of a user within the CRM client application;
receiving, by the user interface element, a prompt from the user;
transmitting, by an orchestrator, the prompt and the context data to a large language model (LLM) endpoint;
receiving, by the orchestrator, a response from the LLM endpoint; and
displaying, by the user interface element, a result based on the response.

14. The method of claim 13, further comprising:
transmitting, by the orchestrator, a list of available functions to the LLM endpoint;
receiving, by the orchestrator, a function call request from the LLM endpoint indicating a selected function from the list of available functions;
executing, by the orchestrator, the selected function to obtain function results; and
transmitting, by the orchestrator, the function results to the LLM endpoint.

15. The method of claim 13, further comprising:
performing, by the orchestrator, a semantic search against a vector database storing vectorized representations of approved content from a controlled content repository; and
providing, by the orchestrator, search results to the LLM endpoint for summarization.

16. The method of claim 13, further comprising:
detecting, by a compliance model, non-compliant content in free text input associated with the CRM client application; and
providing, by the orchestrator, a suggested remedial action to address the non-compliant content.

17. The method of claim 13, wherein the context data includes an account identifier associated with an account being viewed by the user, and wherein the response includes information related to the account.

18. The method of claim 13, further comprising:
detecting an error condition within the CRM client application;
identifying, by the orchestrator, a suggested fix for the error condition based on reference documentation; and
presenting, by the user interface element, the suggested fix to the user.

19. A non-transitory computer-readable medium storing instructions that, when executed by a processor, cause the processor to perform operations comprising:
displaying a user interface element within a customer relationship management (CRM) client application, the user interface element providing access to a chat dialogue and being accessible from a plurality of screens within the CRM client application;
capturing context data based on a current location of a user within the CRM client application;
receiving a prompt from the user via the user interface element;
transmitting, via an orchestrator, the prompt, the context data, and a list of available functions to a large language model (LLM) endpoint;
receiving, via the orchestrator, a response from the LLM endpoint, wherein the response includes at least one of a summarized result or a function call request; and
displaying a result based on the response via the user interface element.

20. The non-transitory computer-readable medium of claim 19, wherein the operations further comprise:
performing a semantic search against a vector database based on the prompt to identify relevant content from a controlled content repository; and
providing the relevant content to the LLM endpoint for incorporation into the response.
